(19) United States
(12) Patent Application Publication
(10) Pub. No.: US 2025/0023077 A1
(43) Pub. Date: Jan. 16, 2025

(54) SYSTEM AND PROCESS FOR REBALANCING FLOW BATTERY STATE OF CHARGE

(71) Applicant: Quino Energy, Inc., San Leandro, CA (US)

(72) Inventors: Eugene S Beh, Menlo Park, CA (US); Meisam Bahari, Alameda, CA (US)

(21) Appl. No.: 18/710,940

(22) PCT Filed: Nov. 16, 2022
(86) PCT No.: PCT/US2022/079952

§ 371 Date: May 16, 2024

Related U.S. Application Data
(60) Provisional application No. 63/279,928, filed on Nov. 16, 2021.

(51) Int. Cl. H01M 8/06; H01M 8/04186; H01M 8/18

(52) U.S. Cl. CPC H01M 8/0693; H01M 8/04186; H01M 8/188

(57) ABSTRACT

Improvements to flow battery systems are described herein that maintain the state of charge of such batteries while maintaining osmotic pressure within the battery itself Flow batteries and methods for maintaining state of charge therein are disclosed herein that do not require the use of flammable hydrogen stores or complex power supply apparatuses. The redox flow better system comprises a first tank containing negolyte and a second tank containing posolyte and a rebalancing apparatus comprising a first and second electrode.

This application is being filed on 16 Nov. 2022, as a PCT International Patent application and claims the benefit of and priority to U.S. Provisional patent application Ser. No. 63/279,928, filed Nov. 16, 2022, the entire disclosure of which is incorporated by reference herein in its entirety.

### TECHNICAL FIELD

This invention relates generally to energy storage. More specifically, embodiments relate to electrochemical rebalancing systems, devices, and methods that regulate the state of charge of redox flow battery reactants.

### BACKGROUND

A flow battery takes two liquid or solution-phase chemicals—a negative electrolyte (also called the anolyte or the negolyte) and a positive electrolyte (also called the catholyte or the posolyte)—and reacts them at the negative and positive electrodes respectively of a device called a flow battery stack, which is composed of one or more flow battery cells. These flow battery cells are electrochemical cells. The battery stack extracts electrical energy from the chemical reaction. The spent chemicals are retained in their separate tanks and can be recharged with electricity from sources like solar panels, which makes the chemical reaction go in reverse.

Because the same stack is operated as a galvanic cell during flow battery discharge and as an electrolytic cell during flow battery charging, for the sake of clarity, the terms anode, cathode, anolyte, or catholyte will not be used in the rest of this document. This is because, the same electrode can be called an anode or cathode depending on whether the cell is being charged or discharged. The terms negative electrode, positive electrode, negolyte, or posolyte will be used instead.

Flow batteries have an advantage over solid-electrode batteries like Li-ion when it comes to longer durations of energy storage. Longer duration batteries can be created by simply using larger tanks of posolyte or negolyte, without spending money on an unnecessarily large flow battery stack. One practical consideration of flow batteries that are operated under realistic conditions is the effect of atmospheric oxygen on the reactants over time. Conceptually, a flow battery is a sealed system that is not open to the outside atmosphere, but in reality, oxygen in the air can diffuse through the walls of plastic electrolyte tanks or enter through microscopic leaks and cracks that could be present throughout the flow battery system, including the electrolyte tanks, the tubing or piping, tube fittings, pumps, the flow battery cell or stack, and so on.

Many examples of flow batteries use at least one reactant that is reactive with oxygen in at least one redox state. For example, flow battery negolytes that comprise viologens, quinones, chromium, and so on are readily converted from their reduced forms to their oxidized forms as a result of reaction with oxygen. Additionally, dissolved oxygen in the negolyte can be reduced to hydroxide at the negative electrode of the battery.

The deleterious effect of oxygen on the long-term operation of flow batteries is illustrated in FIG. 1. For simplicity, enough negolyte and posolyte are provided in this illustration of a flow battery to store 100 amp-hours (Ah) of charge in each electrolyte. The negolyte and posolyte are circulated into and out of the flow battery stack (the rectangle between negolyte and posolyte tanks, with accompanying pumps not shown) where they come into contact with the negative electrodes and positive electrodes respectively (not shown). An ion-selective membrane (also not shown) separates the negative and positive electrodes and prevents the negolyte and posolyte from mixing, while still permitting charge to flow in the form of small ions. These ions can be protons (or hydronium ions), alkali metal ions, halide ions, sulfate ions, ammonium ions, perchlorate ions, and so on. These ions can be of the same charge sign (positive or negative) as the redox-active species in the posolyte and negolyte, or they can be of a different charge sign. The exact ions, or combinations of ions, that cross the membrane depends on the type of membrane (e.g. anion-selective or cation-selective membranes), the negolyte and posolyte pH, and the composition of the negolyte and posolyte solutions themselves.

In the fully discharged state (FIG. 1a), the negolyte exists completely in an oxidized state and the posolyte exists completely in a reduced state (represented here as 0/100 Ah). When an external potential is applied to the negative electrode and the positive electrode of the flow battery stack, the flow battery is charged as electrons are extracted from the posolyte (i.e. the posolyte is oxidized) and transferred to the negolyte (i.e. the negolyte is reduced). Electrons therefore flow across the external circuit from the positive electrode to the negative electrode, with ions flowing across the ion-selective membrane from the posolyte to the negolyte, or vice versa according to the sign of the ion, to ensure charge neutrality is preserved. In the fully charged state, (represented as 100/100 Ah, FIG. 1b), the negolyte exists in a fully reduced state and the posolyte exists in a fully oxidized state. Note that the negolyte or posolyte may each have more than two accessible redox states, in which case the term “fully” may not be accurate, but in this example they each have two accessible redox states. Finally, the charged flow battery can be discharged, with electron and ion flow in the opposite direction compared to the charging process, thereby returning it to the original, discharged state (0/100 Ah, FIG. 1c). The flow battery capacity in this example is therefore 100 Ah.

Complications arise when oxygen reacts with the negolyte and/or the posolyte. Most frequently, as noted above, the negolyte in its reduced state can be reoxidized, and thereby discharged, by oxygen. In this case, part of the negolyte is discharged due to the effect of oxygen on the reduced negolyte during the charging (FIG. 1d), storage (not shown), and discharging (FIG. 1e) process. Even though this change is reversible, it introduces an imbalance to the state of charge (SOC) of each electrolyte, thereby reducing the net capacity of the flow battery to 98 Ah. The SOC of an electrolyte solution is the percentage of all the redox-active active material in the solution that is in the “charged”, or more energized, state. In the case of the negolyte, it is the percentage of redox-active negolyte that is reduced, and in the case of the posolyte, it is the percentage of redox-active posolyte that is oxidized. For example, if a negolyte solution has 20% of the active material in the reduced state and 80% in the oxidized state, the negolyte SOC would be 20%. If a posolyte solution has 25% of the active material in the reduced state and 75% in the oxidized state, the posolyte SOC would be 75%. The SOC of a redox flow battery is the charge stored in a redox flow battery at any given time which can be extracted by discharging the flow battery, as a percentage of the maximum charge that can be stored in the flow battery. So a redox flow battery with a negolyte having 20/100 Ah of capacity and a posolyte having 60/100 Ah of capacity would have a negolyte with 0/100 Ah of capacity and a posolyte with 40/100 Ah of capacity if it were fully discharged, and a negolyte with 60/100 Ah of capacity and a posolyte with 100/100 Ah of capacity if it were fully charged. The capacity of the flow battery comprising these negolyte and posolyte solutions is therefore 60 Ah and the SOC of the flow battery would be 20/60=33.3%. Note that one feature of flow batteries is that the amounts, volumes, or charge capacities of the posolyte and negolyte do not have to be equal. One of them can be greater than the other. Equal capacities are presented in FIG. 1 for simplicity.

Eventually, after many cycles in the presence of oxygen, the capacity of the flow battery will drop significantly (FIG. 1f) as a result of the growing SOC imbalance between the posolyte and the negolyte, even if none of the redox-active material has been lost due to leakage, decomposition, and so on. Certain passive methods, such as better system sealing to exclude oxygen, or pressurizing the headspace of the posolyte and negolyte reservoir with inert gas, may delay but will not reverse the effect of an SOC imbalance. A system or process to remove the SOC imbalance (or preserve the SOC balance) between the posolyte and negolyte is therefore necessary for sustainable, long-term operation of flow batteries in real-world conditions.

There are other mechanisms that can induce an SOC imbalance into a flow battery system through parasitic reactions, such as hydrogen evolution at the negative electrode during charging, oxygen evolution at the positive electrode during charging. This is commonly encountered in flow batteries that use metallic reactants that function as electrocatalysts for these side reactions, such as an iron/iron chemistries (e.g., Fe(0)/Fe(II) negolyte, Fe(II)/Fe(III) posolyte) or use reactants that are likely to contain certain metallic contaminants that are electrocatalysts for these side reactions. Some flow battery chemistries that are designed to plate out metals such as zinc or iron at the negative electrode during charging can also have the plated metal be corroded by the acidic or basic electrolyte to form hydrogen gas. Several types of rebalancing cells have been reported to date. Some of them utilize hydrogen gas as a chemical or electrochemical rebalance reactant, others use iron ions and metallic iron in acidic medium as the rebalance reactant, and still others use photochemical cells in addition to chemical and electrochemical cells. Other rebalancing cells are focused on restoring an appropriate pH in the negolyte and posolyte solutions and do not appreciably change the SOC of either electrolyte solution, by incorporating a bipolar membrane in a three-chambered rebalancing cell and flowing either the negolyte or posolyte, but not both, into the electrode compartments of the rebalancing cell.

One of the key advantages of aqueous organic flow batteries is the non-flammable nature of the system. Use of rebalancing systems that use flammable hydrogen gas as a rebalance reactant therefore defeats the purpose of such systems and restricts their use in environments where the non-flammable nature is a requirement or an advantage. It is similarly inconvenient to furnish an external supply of rebalance reactant, whether flammable or not. Additionally, photochemical rebalancing cells will also require a light source that is not always practical and adds cost.

It would therefore be desirable to provide a system that can maintain the SOC of an aqueous organic flow battery without adding flammability, complexity, or cost in the manner described above. Recent advances in aqueous organic battery technology include methods which do not require an external rebalance reagent. Both methods couple the reduction of either the negolyte or posolyte to oxygen evolution from a positive electrode. In one such method, Poli et al. have discovered a rebalancing technique for vanadium redox flow batteries. Poli et al., Novel electrolyte rebalancing method for vanadium redox flow batteries, 405 Chem. Eng. J 126583 (2021). In this method, a portion of the posolyte is fed into a rebalancing cell. The posolyte is brought in contact with the positive and negative electrodes of the rebalancing cell, where an electrical current reduces the SOC of the vanadium species at the rebalancing cell negative electrode, and oxygen evolution takes place at the rebalancing cell positive electrode, which comprises iridium (IV) oxide (IrO₂) as an oxygen evolution catalyst.

This method has some drawbacks, however. The Coulombic efficiency of the rebalancing is low at around 80%; in comparison, the average Coulombic efficiency of flow batteries routinely exceeds 99%. The low Coulombic efficiency of this process likely comes from two sources: (a) overreduction at the rebalancing cell negative electrode, and (b) the posolyte active material that is allowed to contact the rebalancing cell positive electrode. If the posolyte SOC is lower than 100%, then some of the current at the rebalancing cell positive electrode will go towards reducing the posolyte rather than oxidizing water to evolve oxygen. Next, the rebalancing system required monitoring of the negolyte SOC with a UV/Vis spectrophotometer and a numerical model to determine the optimal end point of the rebalancing, which is laborious and adds cost. Finally, the IrO₂ oxygen evolution electrocatalyst is also extremely expensive, which makes the rebalancing cell comparable in cost to the parent flow battery system itself.

In the second method, reported by Páez et al., the redox flow battery cell itself is used as the rebalancing cell rather than an external system. Páez et al., Mitigating Capacity Fading in Aqueous Organic Redox Flow Batteries through a Simple Electrochemical Charge Balancing Protocol. J. Power Sources. 2021, 512, 230516. There, a quinone or phenazine negolyte is paired with a ferrocyanide/ferricyanide posolyte (Fe(CN)) at strongly alkaline pH. Absorbed oxygen is released at the positive electrode of the flow battery cell by applying a charging voltage that is far above the typical charging voltage normally encountered when charging flow batteries. This voltage is sufficiently high to cause oxygen evolution to take place at the positive electrode. While the authors of this report used graphite felt as the positive electrode, they also raised the possibility of including oxygen evolution reaction (OER) catalysts on the positive electrode, such as Ni(OH)₂, to encourage oxygen evolution.

There are several additional drawbacks to this method. The first is that because the same electrodes are used to charge and discharge the redox flow battery, and also for the rebalancing process, rebalancing cannot be carried out at the same time as cycling of the redox flow battery. Second, the positive electrode materials in this report (carbon) are generally incompatible with the high voltages required for oxygen evolution, tending to get oxidized themselves in the process.

In both the above examples that couple a rebalancing process to oxygen evolution at one electrode, even though the rebalancing process does indeed restore electrochemical balancing between the negolyte and posolyte reservoirs, this comes at the expense of introducing an osmotic imbalance between the two reservoirs. Oxygen reduction at the negolyte or the negative electrode introduces hydroxide ions to the negolyte solution, but oxygen evolution at the positive electrode depletes hydroxide ions from the posolyte solution, according to the half-cell equations:

O₂+2H₂O+4e⁻→4OH⁻--------OH⁻ ions are produced Negative electrode:

4OH⁻→O₂+2H₂O+4e⁻-------OH⁻ ions are consumed Positive electrode:

The net result is an increase in osmotic pressure in the negolyte and a decrease in osmotic pressure in the posolyte, which in turn results in water transport from the posolyte to the negolyte that also causes the negolyte to be diluted, the posolyte to be concentrated, and eventually leads to cell failure. In fact, Páez et al. identify undesired water transport through this osmotic imbalance as a major issue that is unsolved.

Finally, it has been reported that some quinone reactants, when used as redox flow battery negolytes, undergo a decomposition process that can be reversed through aeration or electrochemical oxidation, leading to recovery of lost redox flow battery capacity. A rebalancing cell that is additionally capable of capacity recovery on the negolyte would be enabling and has not yet been reported.

Thus, it would be desirable to increase the SOC of aqueous organic batteries without introducing imbalances in osmotic pressure or causing decomposition, thereby maintaining the lifespan and usability of the battery.

### BRIEF DESCRIPTION OF THE DRAWINGS

The discussion below refers to the following figures, wherein the same reference number may be used to identify the similar/same component in multiple figures.

However, the use of a number to refer to a component in a given figure is not intended to limit the component in another figure labeled with the same number. The figures are also not necessarily to scale.

FIG. 1 depicts the charging and discharging of an idealized flow battery, showing how an SOC imbalance in the negolyte and posolyte can accumulate as a result of oxygen. This SOC imbalance has the effect of reducing the flow battery capacity.

FIG. 2 is a schematic diagram of a redox flow battery and rebalancing cell, with the rebalancing cell configured to act on the negolyte solution and a separate supporting electrolyte solution in accordance with certain embodiments;

FIG. 3 is a schematic diagram of a redox flow battery and rebalancing cell, with the rebalancing cell configured to act on the posolyte solution and a separate supporting electrolyte solution in accordance with certain embodiments;

FIG. 4 is a schematic diagram of a redox flow battery and rebalancing cell, with the rebalancing cell configured to act on the negolyte solution in accordance with certain embodiments;

FIG. 5 is a schematic diagram of a redox flow battery and rebalancing cell, with the rebalancing cell configured to act on the posolyte solution in accordance with certain embodiments;

FIG. 6 is a schematic diagram of a redox flow battery with a rebalancing cell integrated into the negolyte tank and configured to act on the negolyte solution in accordance with certain embodiments;

FIG. 7 is a schematic diagram of a redox flow battery with a rebalancing cell integrated into the posolyte tank and configured to act on the posolyte solution in accordance with certain embodiments;

FIG. 8 is a schematic diagram of a redox flow battery and rebalancing cell, with the rebalancing cell configured to act on the negolyte and posolyte solutions in accordance with certain embodiments;

FIG. 9 is a schematic diagram of a redox flow battery and rebalancing cell, with the rebalancing cell configured to act on the negolyte and posolyte solutions in accordance with certain embodiments;

FIG. 10 is a schematic diagram of a redox flow battery and rebalancing cell, with the rebalancing cell configured to act on the negolyte and posolyte solutions in accordance with certain embodiments;

FIG. 11 is a schematic diagram of a redox flow battery and rebalancing cell, with the rebalancing cell configured to act on the negolyte and posolyte solutions in accordance with certain embodiments; and

FIGS. 12-14 are flow diagrams of methods in accordance with certain embodiments.

FIG. 15 depicts capacity and coulombic efficiency of a cycling cell with rebalancing performed intermittently.

### DESCRIPTION OF THE INVENTION

In light of the rebalancing cells and systems that have been reported to date for redox flow batteries, a rebalancing cell that is relatively cheap and simple to operate is highly desirable for commercial deployment of redox flow battery systems.

A first electrochemical system is described herein comprising a redox flow battery and a second electrochemical system comprising a rebalancing cell. The redox flow battery can comprise a large variety of chemistries for the negolyte and posolyte, including vanadium-vanadium, zinc-bromine, chromium-iron, iron-iron, metal complexes paired with metal complexes, metal complexes paired with ferrocyanide/ferricyanide (Fe(CN)), quinones paired with Fe(CN), viologen derivatives paired with ferrocene derivatives, and many other examples in the prior art. One or both of the negolyte and posolyte solutions can also comprise one or more supporting electrolytes, which are typically added to ensure that the solutions are at the correct pH and to improve the electrical conductivity of the negolyte and posolyte solutions. Examples of supporting electrolytes include strong acids such as sulfuric acid or hydrochloric acid, strong bases such as sodium hydroxide or potassium hydroxide, neutral salts such as sodium sulfate or potassium chloride, or pH buffers such as potassium dihydrogen phosphate, dipotassium hydrogen phosphate, sodium bicarbonate, and so on. The negolyte and posolyte solutions may also include additives to improve the solubility of the active materials in the solutions. The solvent of the negolyte and posolyte solutions is water.

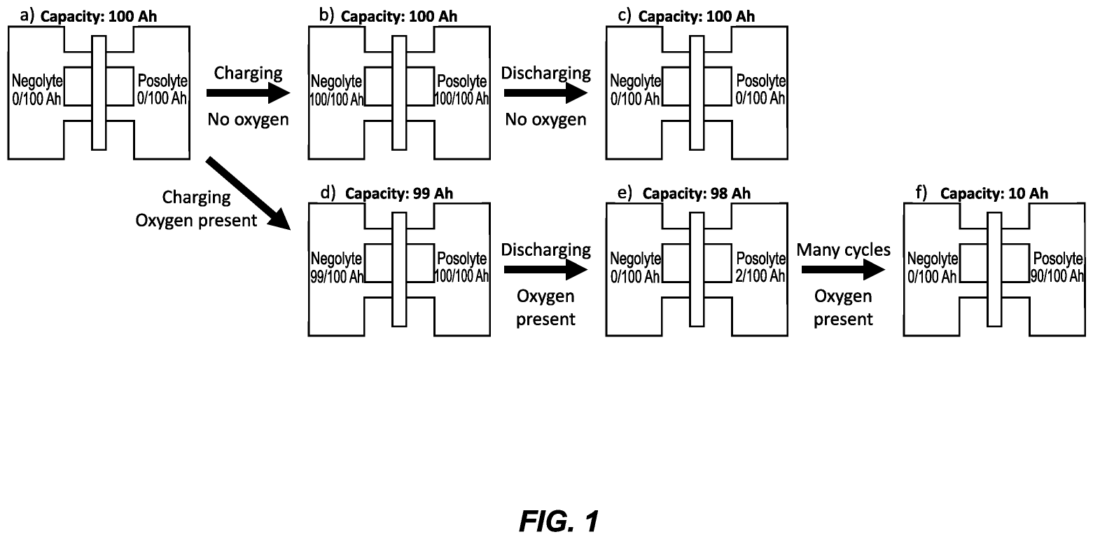

The amount, volume, or charge capacity of the negolyte and posolyte solutions do not have to be equal or substantially equal to each other. They can be any arbitrary amount. In some embodiments, it is advantageous to supply an excess of either the negolyte or the posolyte in the redox flow battery. In this way, the redox flow battery is able to undergo a greater amount of parasitic reactions before rebalancing is required. This would enable the rebalancing to be conducted less frequently. In the example above, going from FIG. 1a→FIG. 1d→FIG. 1e→FIG. 1f, the posolyte quickly becomes the capacity-limiting side of the redox flow battery. If the posolyte capacity had been 110 Ah instead of 100 Ah, the system would have been about to maintain its accessible capacity at the full 100 Ah until the posolyte had hit an SOC of 10/110 Ah in the fully discharged state of the flow battery, rather than losing its accessible capacity from the beginning.

The redox flow battery can also comprise just a single electrochemical cell or comprise more than one cell, of the same or different sizes, arranged in series or parallel, to form an electrochemical stack; hereafter, use of the terms “cell” or “stack” should also be understood to be interchangeable, i.e. one or more cells, when referring to this or any other electrochemical system should also.

The rebalancing cell comprises a rebalancing cell negative electrode and a rebalancing cell positive electrode, separated by zero, one, or two separators to define one, two, or three distinct chambers respectively. The separators can independently be microporous separators (e.g. Celgard), anion exchange membranes, cation exchange membranes, bipolar membranes, or any combination thereof. The rebalancing cell is configured to accept a fluid input from the negolyte or posolyte reservoir, into at least one of the chambers of the system, said chamber comprising the rebalancing cell negative electrode, and output the fluid back to the same negolyte or posolyte reservoir. Fluid that moves from the negolyte reservoir therefore flows past the rebalancing cell negative electrode and is returned to the negolyte reservoir, or fluid from the posolyte reservoir flows past the rebalancing cell negative electrode and is returned to the posolyte reservoir. In some embodiments, the rebalancing cell can be reversibly fluidically disconnected from or reconnected to the negolyte or posolyte reservoirs, as desired, by means of valves or similar flow controllers. In some embodiments, the rebalancing cell is not separated from either the negolyte or posolyte reservoirs, but is integrated into one of the negolyte or posolyte reservoirs. In other embodiments, the rebalancing cell is integrated into one of the negolyte or posolyte reservoirs as before, but the electrodes can be kept from contacting the negolyte or posolyte solutions by means of withdrawing the electrodes, surrounding the electrodes with air or an inert gas, valves integrated into the negolyte or posolyte reservoirs, and so on. In some embodiments where the rebalancing cell is integrated into a negolyte or posolyte reservoir, circulation of the negolyte around the rebalancing cell negative electrode and the rebalancing cell positive electrode may be effected by means of additional pumps, the existing pumps of the redox flow battery, magnetic stirrers, mechanical stirrers, agitators, and so on. The chamber containing the rebalancing cell positive electrode, where distinct from the chamber containing the rebalancing cell negative electrode, is configured to accept either the same fluid stream as the chamber containing the rebalancing cell negative electrode, or a solution comprising only the supporting electrolyte but no negolyte or posolyte active material.

In the case of two separators in the rebalancing cell, the middle chamber that is defined by the two separators on either side is configured to accept either the same fluid stream as the chamber containing the rebalancing cell negative electrode, the same fluid stream as the chamber containing the rebalancing cell positive electrode, or a solution comprising only the supporting electrolyte but no negolyte or posolyte active material. The middle chamber of the rebalancing cell does not contain any positive or negative electrode. Instead, these two electrodes are located in the two different chambers, or side chambers, that flank the middle chamber of the rebalancing cell. In all cases with a three-chamber, two-separator rebalancing cell, the negolyte solution is flowed through one of the side chambers and the posolyte solution is flowed through the other side chamber.

The rebalancing cell negative electrode is configured to provide electrons to, and thereby perform electrochemical reduction on, the active material in the stream of posolyte or negolyte in contact with the electrode. This has the effect of raising the SOC of a negolyte stream or lowering the SOC of a posolyte stream. The rebalancing cell negative electrode can comprise a metallic material such as gold, platinum, stainless steel, titanium, nickel, and so on, or a conductive carbon material such as a carbon felt, carbon foam, carbon paper, glassy carbon, graphite felt, carbon black, carbon nanotubes and so on. An electrocatalyst may optionally also be present on the rebalancing cell negative electrode. In some embodiments, the rebalancing cell negative electrode comprises the same material as the redox flow battery negative electrode if configured to accept the negolyte, or the same material as the redox flow battery positive electrode if configured to accept the posolyte.

The rebalancing cell positive electrode is configured to accept electrons from, and thereby perform electrochemical oxidation on, the solvent (water) in the solution in contact with the electrode. This has the effect of producing gaseous oxygen at the rebalancing cell positive electrode. Depending on what other species are present in the solution that contacts the rebalancing cell positive electrode, other electrochemical reactions such as oxidation of the active material in the stream of posolyte or negolyte may take place simultaneously with oxygen evolution. The rebalancing cell positive electrode can comprise a metallic material such as gold, platinum, stainless steel, titanium, nickel, and so on, or a conductive carbon material such as a carbon felt, carbon cloth, carbon foam, carbon paper, glassy carbon, graphite felt, carbon black, carbon nanotubes and so on. An electrocatalyst may optionally also be present on the rebalancing cell positive electrode. In some embodiments, when the stream in contact with the rebalancing cell positive electrode is at an alkaline pH, the electrode comprises a nickel-iron alloy with nickel-iron oxyhydroxide acting as a water oxidation electrocatalyst. In embodiments where the rebalancing cell positive electrode is integrated into the same reservoir as the negolyte or posolyte, conduits, tubes, guides or the like can be provided to catch, gather, and guide bubbles of evolved oxygen gas through an outlet to the outside of the reservoir. Regardless of the exact configuration, this outlet is ideally positioned near the rebalancing cell positive electrode in order to minimize the distance that the bubbles have to travel before the can escape the system.

When a sufficiently high electrical potential is applied to the electrodes of the rebalancing cell, the net effect is to raise the SOC of the input negolyte stream or lower the SOC of the input posolyte stream, with oxygen formed as a separate gaseous output that leaves the rebalancing cell and the redox flow battery. The electrical potential may be applied galvanostatically (i.e., constant current), potentiostatically (i.e., constant voltage), as a pulse of current or voltage, as a series of steps of constant currents or voltages, or any combination thereof. A one-way valve, such as a check valve, may be provided for the oxygen outlet. The outlet may be completely passive or optionally fitted with a pump to extract the evolved oxygen gas. The rebalancing cell can be operated continuously (at constant or variable current, or at constant or variable voltage), at scheduled times (e.g. once a day, once a week, once a month, once a year, once per charge-discharge cycle on the redox flow battery, once per ten cycles on the redox flow battery, once per hundred cycles on the redox flow battery, once per thousand cycles on the redox flow battery, or so on), intermittently on an as-needed basis in order to maximize the accessible capacity of the attached redox flow battery, or some combination thereof. In certain embodiments, the average rate of oxygen production from the rebalancing cell positive electrode is approximately equal to the rate of oxygen absorption and reduction happening in the redox flow battery, such that the SOC balance between the negolyte and the posolyte is greatly extended or indefinitely preserved.

In some embodiments where the rebalancing cell is configured to perform oxygen evolution (water oxidation) on the negolyte solution, the rebalancing cell can also be used to simultaneously reverse the decomposition of degraded negolyte reactants through electrochemical oxidation back to the original negolyte reactants. The rebalancing cell can also optionally be operated at a lower voltage (e.g., below the water splitting potential of 1.23V) in order to restore lost negolyte capacity without modifying the negolyte SOC through oxygen evolution as described above.

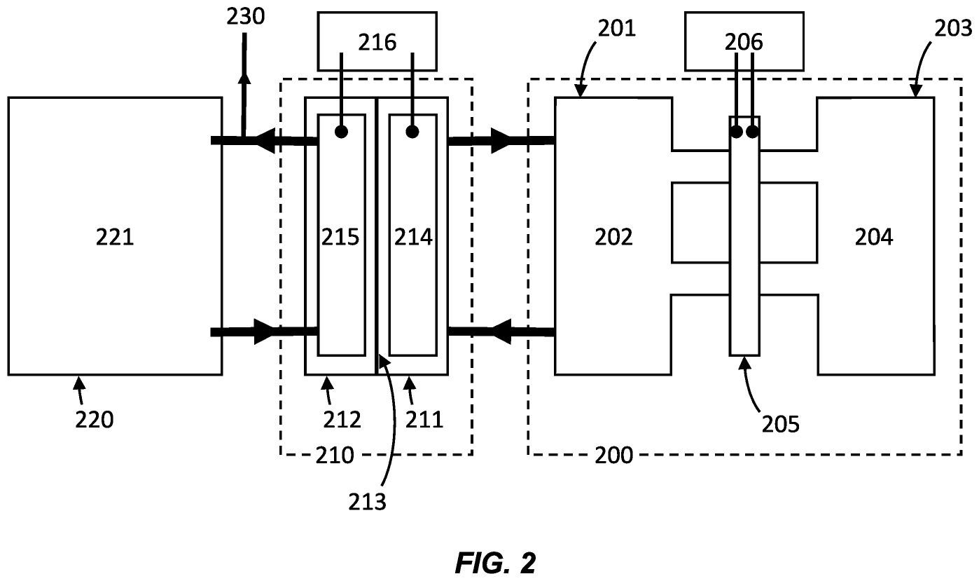

FIG. 2 shows a redox flow battery 200 and rebalancing cell 210 in accordance with some embodiments of the present invention. The flow battery 200 comprises a negolyte tank 201 filled with a negolyte solution 202, a posolyte tank 203 filled with a posolyte solution 204, and a redox flow battery stack 205 that is connected to an external load or power supply 206. The negolyte solution 202 can be a negatively charged quinone derivative dissolved in water, and the posolyte solution 204 can be a negatively charged Fe(CN) solution dissolved in water. Both the negolyte and posolyte solutions 202, 204 can use potassium hydroxide, sodium hydroxide, or a mixture of both as a supporting electrolyte. This rebalancing cell 210 comprises a first chamber 211 and a second chamber 212 separated by an ion-selective membrane 213. Those of ordinary skill in the art will recognize that ion-selective membranes can include multiple sub-categories including but not limited to cation-exchange membranes and bipolar membranes. In one embodiment, the ion-selective membrane 213 can be a cation-exchange membrane that lets potassium or sodium ions pass through freely. The first chamber 211 contains a first electrode 214 and the second chamber 212 contains a second electrode 215. The first electrode 214 can comprise a conductive carbon material such as carbon cloth with no other electrocatalyst, and the second electrode 215 can comprise nickel/iron oxyhydroxide. The two electrodes 214, 215 are connected to an external power supply 216.

The negolyte solution 202 is circulated from the negolyte tank 201 to the first chamber 211 and back again to the negolyte tank 201. A solution of supporting electrolyte 221 is circulated from a supporting electrolyte tank 220 to the second chamber 212 and back to the supporting electrolyte tank 220.

When an appropriate electrical potential is applied across the electrodes 214, 215 of the rebalancing cell 210 using external power supply 216, the negolyte solution 202 is reduced (its SOC is raised) at the first electrode 214. At the same time, water (or hydroxide ions) in the supporting electrolyte solution 221 is oxidized at the second electrode 215 to form oxygen gas that leaves the rebalancing cell 210 and is allowed to escape 230 outside the system. If the ion-selective membrane 213 is a cation-exchange membrane or anion-exchange membrane, cations or anions respectively flow across the ion-selective membrane in order to balance the charge at both reservoirs. If the ion-selective membrane 213 is a bipolar membrane, protons and hydroxide ions are instead created on opposite faces of the bipolar membrane according to how the bipolar membrane is oriented inside the rebalancing cell 210.

This operation is preferably carried out when the SOC of the negolyte solution 202 is less than 100% (e.g., <99%, <90%, <80%, <60%, <40%, <20%, <10%, or 0%), so that it can continue to accept electrons at the first electrode 214. The electrical potential supplied from the external power supply 216 can be changed, reduced, or switched off once the SOC imbalance between the negolyte solution 202 and the posolyte solution 204 decreases below a threshold value.

As hydroxide ions are formed in the negolyte solution 202 through reaction with oxygen, and consumed in the solution of supporting electrolyte 221 during the rebalancing process, the rebalancing process has the tendency to transport water from the solution of supporting electrolyte 221 into the negolyte solution 202 through osmosis. This can be counteracted by equipping the supporting electrolyte tank 220 with a concentrated (e.g. >2 molar concentration) solution of supporting electrolyte 221 such that it has greater osmotic pressure than the negolyte solution 202. Then, flowing the negolyte solution 202 and the solution of supporting electrolyte 221 through the rebalancing cell 210, in the absence of any electrical potential applied by external power supply 216, will cause water to move from the negolyte solution 202 and the solution of supporting electrolyte 221 by osmosis, thereby counteracting water uptake in the opposite direction that would otherwise be expected from the rebalancing process.

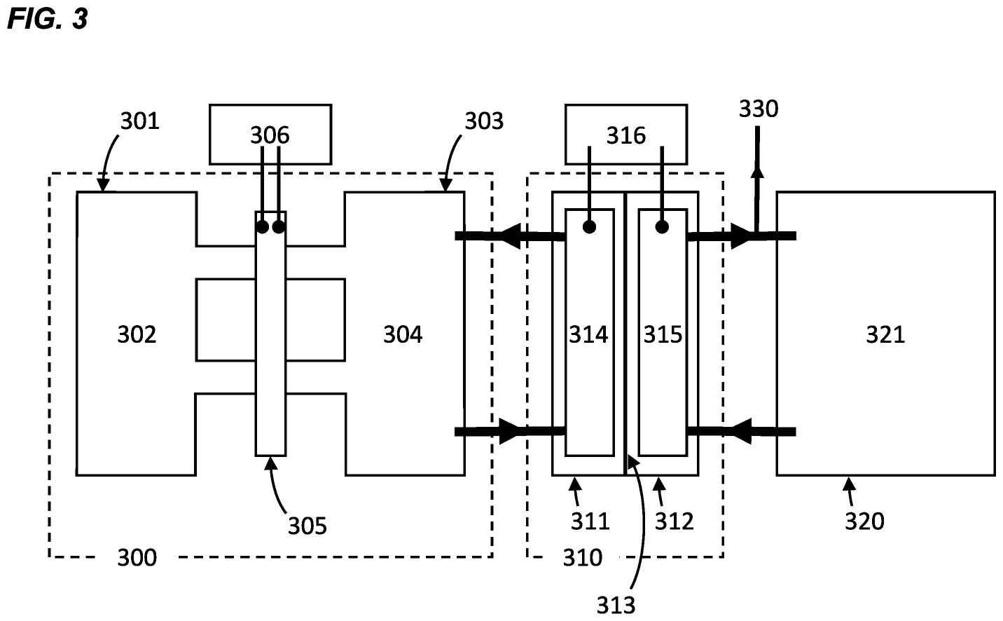

FIG. 3 shows a redox flow battery 300 and rebalancing cell 310 in accordance with some embodiments of the present invention. The flow battery 300 comprises a negolyte tank 301 filled with a negolyte solution 302, a posolyte tank 303 filled with a posolyte solution 304, and a redox flow battery stack 305 that is connected to an external load or power supply 306. The negolyte solution 302 can be a negatively charged quinone derivative dissolved in water, and the posolyte solution 304 can be a negatively charged Fe(CN) solution dissolved in water. Both the negolyte and posolyte solutions 302, 304 can use potassium hydroxide, sodium hydroxide, or a mixture of both as a supporting electrolyte. This rebalancing cell 310 comprises a first chamber 311 and a second chamber 312 separated by an ion-selective membrane 313. Those of ordinary skill in the art will recognize that ion-selective membranes can include multiple sub-categories including but not limited to cation-exchange membranes, anion-exchange membranes, proton-exchange membranes, and bipolar membranes. In one embodiment, the ion-selective membrane 313 can be a cation-exchange membrane that lets potassium or sodium ions pass through freely. The first chamber 311 contains a first electrode 314 and the second chamber 312 contains a second electrode 315. The first electrode 314 can comprise a conductive carbon material such as carbon cloth with no other electrocatalyst, and the second electrode 315 can comprise nickel/iron oxyhydroxide. The two electrodes 314, 315 are connected to an external power supply 316.

The posolyte solution 304 is circulated from the posolyte tank 303 to the first chamber 311 and back again to the posolyte tank 303. A solution of supporting electrolyte 321 is circulated from a supporting electrolyte tank 320 to the second chamber 312 and back to the supporting electrolyte tank 320.

When an appropriate electrical potential is applied across the electrodes 314, 315 of the rebalancing cell 310 using external power supply 316, the posolyte solution 304 is reduced (its SOC is lowered) at the first electrode 314. At the same time, water (or hydroxide ions) in the supporting electrolyte solution 321 is oxidized at the second electrode 315 to form oxygen gas that leaves the rebalancing cell 310 and is allowed to escape 330 outside the system.

This operation is preferably carried out when the SOC of the posolyte solution 304 is greater than 0% (e.g. >1%, >10%, >20%, >40%, >60%, >80%, >90%, or 100%), so that it can continue to accept electrons at the first electrode 314. The electrical potential supplied from the external power supply 316 can be changed, reduced, or switched off once the SOC imbalance between the negolyte solution 302 and the posolyte solution 304 decreases below a threshold value.

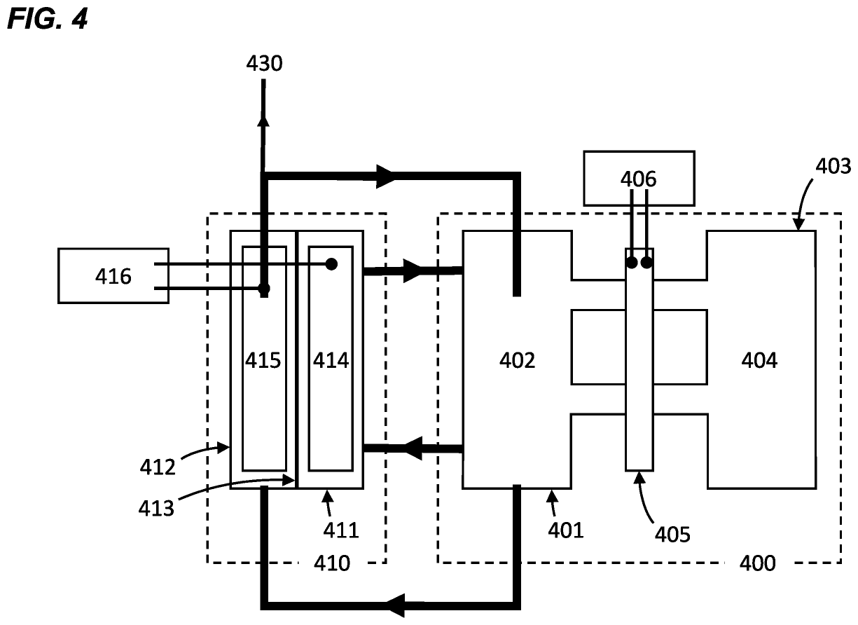

FIG. 4 shows a redox flow battery 400 and rebalancing cell 410 in accordance with some embodiments of the present invention. The flow battery 400 comprises a negolyte tank 401 filled with a negolyte solution 402, a posolyte tank 403 filled with a posolyte solution 404, and a redox flow battery stack 405 that is connected to an external load or power supply 406. The negolyte solution 402 can be a negatively charged quinone derivative dissolved in water, and the posolyte solution 404 can be a negatively charged Fe(CN) solution dissolved in water. Both the negolyte and posolyte solutions 402, 404 can use potassium hydroxide, sodium hydroxide, or a mixture of both as a supporting electrolyte. This rebalancing cell 410 comprises a first chamber 411 and a second chamber 412 separated by an ion-selective membrane 413. The ion-selective membrane 413 can be a cation-exchange membrane that lets potassium or sodium ions pass through freely. The first chamber 411 contains a first electrode 414 and the second chamber 412 contains a second electrode 415. The first electrode 414 can comprise a conductive carbon material such as carbon cloth with no other electrocatalyst, and the second electrode 415 can comprise nickel/iron oxyhydroxide. The two electrodes 414, 415 are connected to an external power supply 416.

The negolyte solution 402 is circulated from the negolyte tank 401 into both the first and second chambers 411, 412 and back again from both the chambers 411, 412 to the negolyte tank 201.

When an appropriate electrical potential is applied across the electrodes 414, 415 of the rebalancing cell 410 using external power supply 416, the negolyte solution 402 is reduced (its SOC is raised) at the first electrode 414. At the same time, water (or hydroxide ions) in the negolyte solution 402 is oxidized at the second electrode 415 to form oxygen gas that leaves the rebalancing cell 410 and is allowed to escape 430 outside the system.

This operation is preferably carried out when the SOC of the negolyte solution 402 is close to or at 0% (e.g. <40%, <20%, <10%, <5%, <2%, <1%, <0.5%, <0.2%, <0.1%, or 0%), so that it can continue to accept electrons at the first electrode 414, and so that the proportion of negolyte solution 402 that is re-oxidized at the second electrode 415 is small relative to the amount of oxygen produced. This also has the benefit of minimizing any reaction between the oxygen that is evolved from second electrode 415 and the negolyte solution 402 before it escapes 430 from the system. The electrical potential supplied from the external power supply 416 can be changed, reduced, or switched off once the SOC imbalance between the negolyte solution 402 and the posolyte solution 404 decreases below a threshold value.

As hydroxide ions are formed in the negolyte solution 402 through reaction with oxygen, but consumed in the same solution at the second electrode 415, there is no net change to the ionic strength (or osmotic potential) of the negolyte solution 402 as a result of oxygen absorption followed by rebalancing that produces oxygen from the same solution. Therefore, this embodiment does not experience any long-term net transport of water from the negolyte solution 402 to the posolyte solution 404, or vice versa. This configuration of rebalancing cell 410 can also be used to convert degraded negolyte 402 back into active negolyte and thereby restore lost capacity.

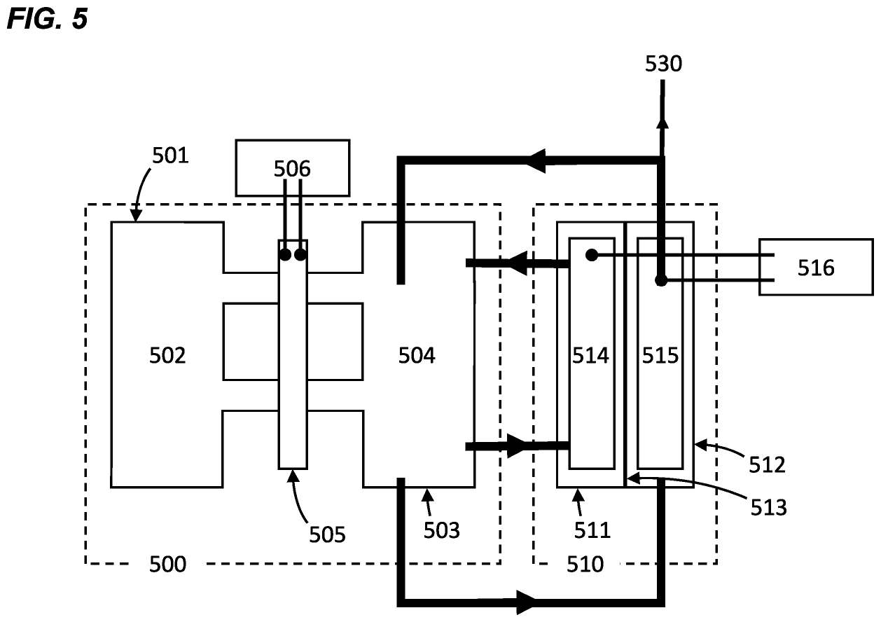

FIG. 5 shows a redox flow battery 500 and rebalancing cell 510 in accordance with some embodiments of the present invention. The flow battery 500 comprises a negolyte tank 501 filled with a negolyte solution 502, a posolyte tank 503 filled with a posolyte solution 504, and a redox flow battery stack 505 that is connected to an external load or power supply 506. The negolyte solution 502 can be a negatively charged quinone derivative dissolved in water, and the posolyte solution 504 can be a negatively charged Fe(CN) solution dissolved in water. Both the negolyte and posolyte solutions 502, 504 can use potassium hydroxide, sodium hydroxide, or a mixture of both as a supporting electrolyte. This rebalancing cell 510 comprises a first chamber 511 and a second chamber 512 separated by an ion-selective membrane 513. The ion-selective membrane 513 can be a cation-exchange membrane that lets potassium or sodium ions pass through freely. The first chamber 511 contains a first electrode 514 and the second chamber 512 contains a second electrode 515. The first electrode 514 can comprise a conductive carbon material such as carbon cloth with no other electrocatalyst, and the second electrode 515 can comprise nickel/iron oxyhydroxide. The two electrodes 514, 515 are connected to an external power supply 516.

The posolyte solution 504 is circulated from the posolyte tank 503 into both the first and second chambers 511, 512 and back again from both the chambers 511, 512 to the posolyte tank 503.

When an appropriate electrical potential is applied across the electrodes 514, 515 of the rebalancing cell 510 using external power supply 516, the posolyte solution 504 is reduced (its SOC is lowered) at the first electrode 514. At the same time, water (or hydroxide ions) in the posolyte solution 504 is oxidized at the second electrode 515 to form oxygen gas that leaves the rebalancing cell 510 and is allowed to escape 530 outside the system.

This operation is preferably carried out when the SOC of the posolyte solution 504 is close to or at 100% (e.g. >60%, >80%, >90%, >95%, >98%, >99%, >99.5%, >99.8%, >99.9%, or 100%), so that it can continue to accept electrons at the first electrode 514, and so that the proportion of posolyte solution 504 that is re-oxidized at the second electrode 515 is small relative to the amount of oxygen produced. This also has the benefit of minimizing any opportunity for the oxygen that is evolved from second electrode 515 to redissolve in the posolyte solution 504 and eventually diffuse back into the negolyte solution 502, rather than escaping 530 from the system. The electrical potential supplied from the external power supply 516 can be changed, reduced, or switched off once the SOC imbalance between the negolyte solution 502 and the posolyte solution 504 decreases below a threshold value.

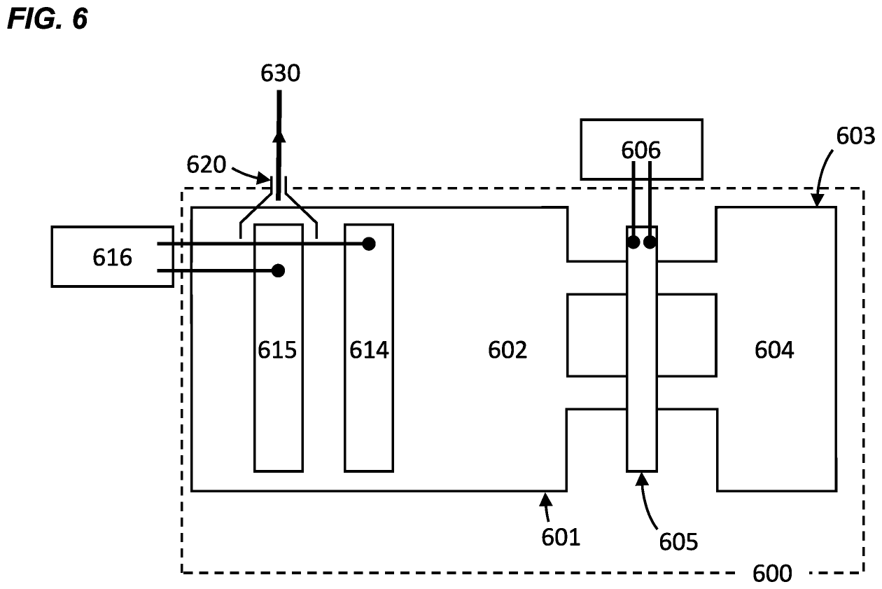

FIG. 6 shows a redox flow battery containing an integrated rebalancing cell 600 in accordance with some embodiments of the present invention. The flow battery containing an integrated rebalancing cell 600 comprises a negolyte tank 601 filled with a negolyte solution 602 and additionally equipped with a first electrode 614 and a second electrode 615, a posolyte tank 603 filled with a posolyte solution 604, and a redox flow battery stack 605 that is connected to an external load or power supply 606. The negolyte solution 602 can be a negatively charged quinone derivative dissolved in water, and the posolyte solution 604 can be a negatively charged Fe(CN) solution dissolved in water. Both the negolyte and posolyte solutions 602, 604 can use potassium hydroxide, sodium hydroxide, or a mixture of both as a supporting electrolyte. The first electrode 614 can comprise a conductive carbon material such as carbon cloth with no other electrocatalyst, and the second electrode 615 can comprise nickel/iron oxyhydroxide. A conduit 620 is positioned to efficiently gather bubbles of oxygen gas that are evolved from the second electrode 615 and guide them outside 630 the flow battery containing an integrated rebalancing cell 600.

When an appropriate electrical potential is applied across the electrodes 614, 615 using external power supply 616, the negolyte solution 602 is reduced (i.e., its SOC is raised) at the first electrode 614. At the same time, water (or hydroxide ions) in the negolyte solution 602 is oxidized at the second electrode 615 to form oxygen gas that is guided by the conduit 620 and is allowed to escape 630 outside the system.

This operation is preferably carried out when the SOC of the negolyte solution 602 is close to or at 0% (e.g. <40%, <20%, <10%, <5%, <2%, <1%, <0.5%, <0.2%, <0.1%, or 0%), so that it can continue to accept electrons at the first electrode 614, and so that the proportion of negolyte solution 602 that is re-oxidized at the second electrode 615 is small relative to the amount of oxygen produced. This also has the benefit of minimizing any reaction between the oxygen that is evolved from second electrode 615 and the negolyte solution 602 before it escapes 630 from the system. The electrical potential supplied from the external power supply 616 can be changed, reduced, or switched off once the SOC imbalance between the negolyte solution 602 and the posolyte solution 604 decreases below a threshold value.

As hydroxide ions are formed in the negolyte solution 602 through reaction with oxygen, but consumed in the same solution at the second electrode 615, there is no net change to the ionic strength (or osmotic potential) of the negolyte solution 602 as a result of oxygen absorption followed by rebalancing that produces oxygen from the same solution. Therefore, this embodiment does not experience any long-term net transport of water from the negolyte solution 602 to the posolyte solution 604, or vice versa. This configuration of redox flow battery containing an integrated rebalancing cell 600 can also be used to convert degraded negolyte 602 back into active negolyte and thereby restore lost capacity.

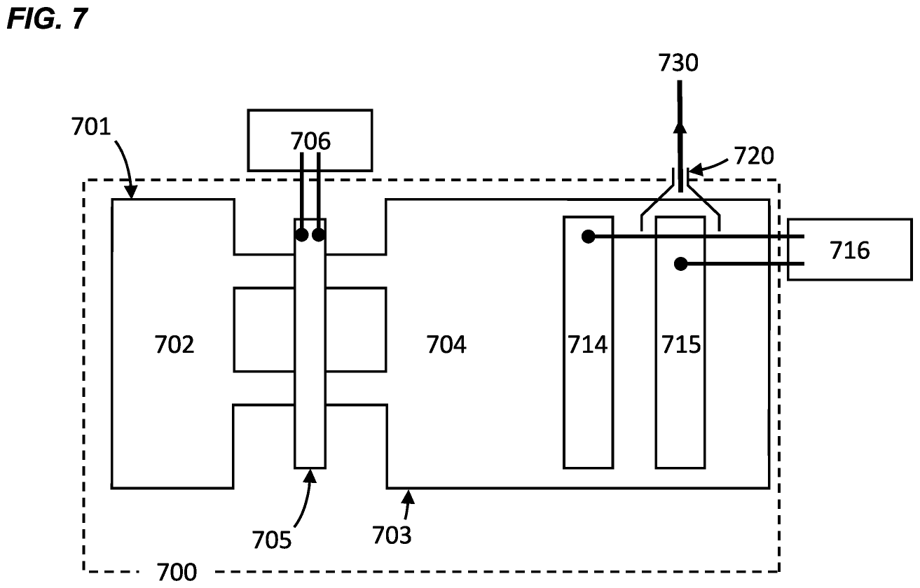

FIG. 7 shows a redox flow battery containing an integrated rebalancing cell 700 in accordance with some embodiments of the present invention. The flow battery containing an integrated rebalancing cell 700 comprises a negolyte tank 701 filled with a negolyte solution 702, a posolyte tank 703 filled with a posolyte solution 704 and additionally equipped with a first electrode 714 and a second electrode 715, and a redox flow battery stack 705 that is connected to an external load or power supply 706. The negolyte solution 702 can be a negatively charged quinone derivative dissolved in water, and the posolyte solution 704 can be a negatively charged Fe(CN) solution dissolved in water. Both the negolyte and posolyte solutions 702, 704 can use potassium hydroxide, sodium hydroxide, or a mixture of both as a supporting electrolyte. The first electrode 714 can comprise a conductive carbon material such as carbon cloth with no other electrocatalyst, and the second electrode 715 can comprise nickel/iron oxyhydroxide. A conduit 720 is positioned to efficiently gather bubbles of oxygen gas that are evolved from the second electrode 715 and guide them outside 730 the flow battery containing an integrated rebalancing cell 700.

When an appropriate electrical potential is applied across the electrodes 714, 715 using external power supply 716, the posolyte solution 704 is reduced (its SOC is lowered) at the first electrode 714. At the same time, water (or hydroxide ions) in the posolyte solution 704 is oxidized at the second electrode 715 to form oxygen gas that is guided by the conduit 720 and is allowed to escape 730 outside the system.

This operation is preferably carried out when the SOC of the posolyte solution 704 is close to or at 100% (e.g. >60%, >80%, >90%, >95%, >98%, >99%, >99.5%, >99.8%, >99.9%, or 100%), so that it can continue to accept electrons at the first electrode 714, and so that the proportion of posolyte solution 704 that is re-oxidized at the second electrode 715 is small relative to the amount of oxygen produced. This also has the benefit of minimizing any opportunity for the oxygen that is evolved from second electrode 715 to redissolve in the posolyte solution 704 and eventually diffuse back into the negolyte solution 702, rather than escaping 730 from the system. The electrical potential supplied from the external power supply 716 can be changed, reduced, or switched off once the SOC imbalance between the negolyte solution 702 and the posolyte solution 704 decreases below a threshold value.

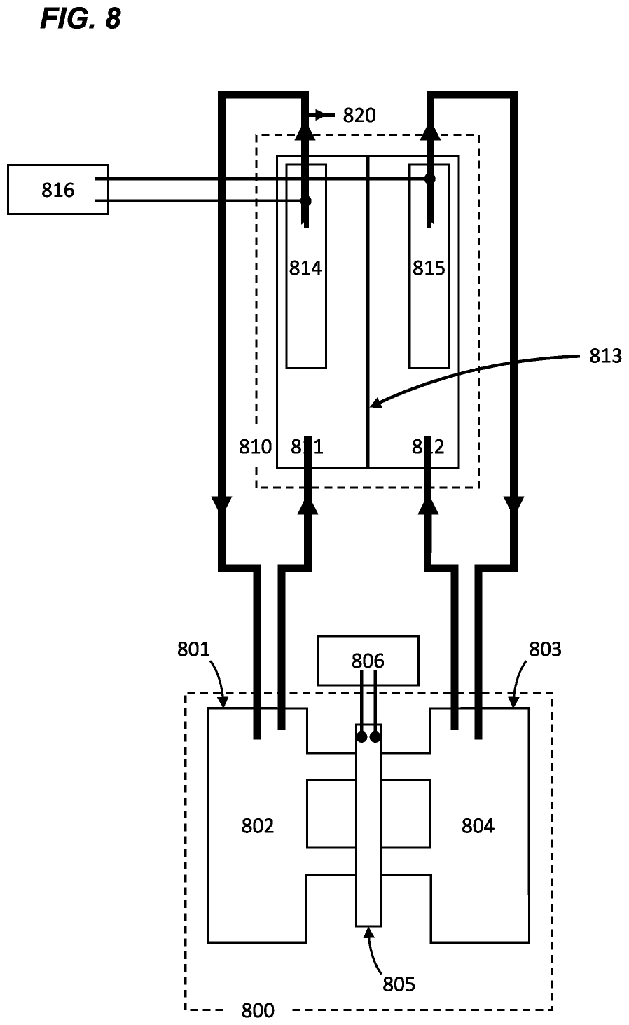

FIG. 8 shows a redox flow battery 800 and rebalancing cell 810 in accordance with some embodiments of the present invention. The flow battery 800 comprises a negolyte tank 801 filled with a negolyte solution 802, a posolyte tank 803 filled with a posolyte solution 804, and a redox flow battery stack 805 that is connected to an external load or power supply 806. The negolyte solution 802 can be a negatively charged quinone derivative dissolved in water, and the posolyte solution 804 can be a negatively charged Fe(CN) solution dissolved in water. Both the negolyte and posolyte solutions 802, 804 can use potassium hydroxide, sodium hydroxide, or a mixture of both as a supporting electrolyte. This rebalancing cell 810 comprises a first chamber 811 and a second chamber 812 separated by an ion-selective membrane 813. The ion-selective membrane 813 can be a cation-exchange membrane that lets potassium or sodium ions pass through freely. The first chamber 811 contains a first electrode 814 and the second chamber 812 contains a second electrode 815. The first electrode 814 can comprise nickel/iron oxyhydroxide, and the second electrode 815 can comprise a conductive carbon material such as carbon cloth with no other electrocatalyst. The two electrodes 814, 815 are connected to an external power supply 816.

The negolyte solution 802 is circulated from the negolyte tank 801 into the first chamber 811 and back again from the first chamber 811 to the negolyte tank 801. Similarly, the posolyte solution 804 is circulated from the posolyte tank 803 into the second chamber 812 and back again from the second chamber 812 to the posolyte tank 803.

When an appropriate electrical potential is applied across the electrodes 814, 815 of the rebalancing cell 810 using external power supply 816, the posolyte solution 804 is reduced (its SOC is lowered) at the second electrode 815. At the same time, water (or hydroxide ions) in the negolyte solution 802 is oxidized at the first electrode 814 to form oxygen gas that leaves the rebalancing cell 810 and is allowed to escape 820 outside the system.

This operation is preferably carried out when the SOC of the posolyte solution 804 is greater than 0% (e.g. >1%, >10%, >20%, >40%, >60%, >80%, >90%, or 100%), so that it can continue to accept electrons at the second electrode 815. It is also preferably carried out when the SOC of the negolyte solution 802 is close to or at 0% (e.g. <40%, <20%, <10%, <5%, <2%, <1%, <0.5%, <0.2%, <0.1%, or 0%), so that the proportion of negolyte solution 802 that is re-oxidized at the first electrode 814 is small relative to the amount of oxygen produced.

This also has the benefit of minimizing any reaction between the oxygen that is evolved from first electrode 814 and the negolyte solution 802 before it escapes 820 from the system. The electrical potential supplied from the external power supply 816 can be changed, reduced, or switched off once the SOC imbalance between the negolyte solution 802 and the posolyte solution 804 decreases below a threshold value.

As hydroxide ions are formed in the negolyte solution 802 through reaction with oxygen, but consumed in the same solution at the first electrode 814, there is no net change to the ionic strength (or osmotic potential) of the negolyte solution 802 as a result of oxygen absorption followed by rebalancing that produces oxygen from the same solution. Therefore, this embodiment does not experience any long-term net transport of water from the negolyte solution 802 to the posolyte solution 804, or vice versa. This configuration of rebalancing cell 810 can also be used to convert degraded negolyte 802 back into active negolyte and thereby restore lost capacity.

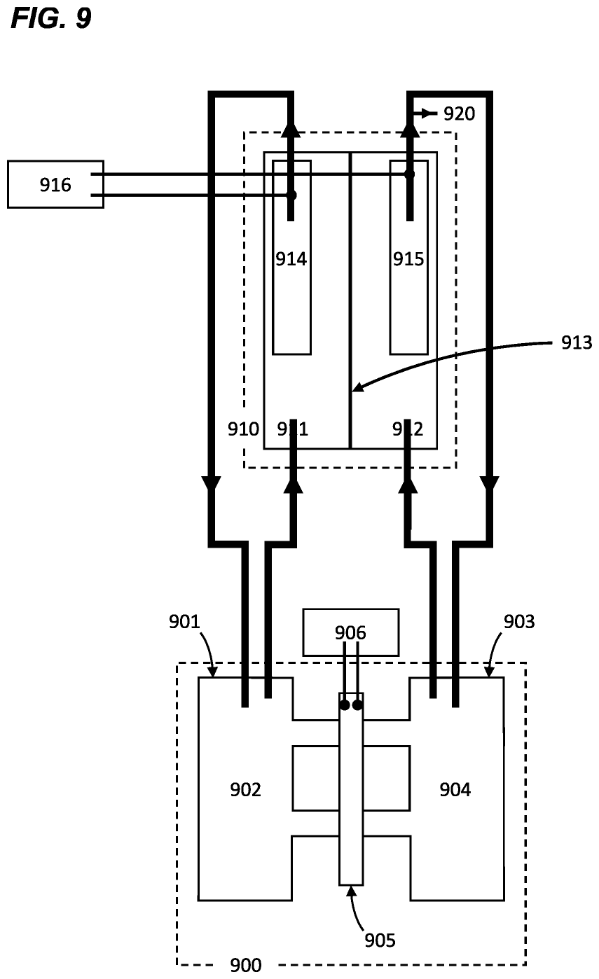

FIG. 9 shows a redox flow battery 900 and rebalancing cell 910 in accordance with some embodiments of the present invention. The flow battery 900 comprises a negolyte tank 901 filled with a negolyte solution 902, a posolyte tank 903 filled with a posolyte solution 904, and a redox flow battery stack 905 that is connected to an external load or power supply 906. The negolyte solution 902 can be a negatively charged quinone derivative dissolved in water, and the posolyte solution 904 can be a negatively charged Fe(CN) solution dissolved in water. Both the negolyte and posolyte solutions 902, 904 can use potassium hydroxide, sodium hydroxide, or a mixture of both as a supporting electrolyte. This rebalancing cell 910 comprises a first chamber 911 and a second chamber 912 separated by a bipolar membrane 913.

The bipolar membrane 913 is positioned such that it generates protons (or hydronium ions) that enter the first chamber 911 and hydroxide ions that enter the second chamber 912 upon the application of a suitable electrical potential across the bipolar membrane 913.

The first chamber 911 contains a first electrode 914 and the second chamber 912 contains a second electrode 915. The first electrode 914 can comprise a conductive carbon material such as carbon cloth with no other electrocatalyst, and the second electrode 915 can comprise nickel/iron oxyhydroxide. The two electrodes 914, 915 are connected to an external power supply 916.

The negolyte solution 902 is circulated from the negolyte tank 901 into the first chamber 911 and back again from the first chamber 911 to the negolyte tank 901. Similarly, the posolyte solution 904 is circulated from the posolyte tank 903 into the second chamber 912 and back again from the second chamber 912 to the posolyte tank 903.

When an appropriate electrical potential is applied across the electrodes 914, 915 of the rebalancing cell 910 using external power supply 916, the negolyte solution 902 is reduced (its SOC is lowered) at the first electrode 914. At the same time, water (or hydroxide ions) in the posolyte solution 904 is oxidized at the second electrode 915 to form oxygen gas that leaves the rebalancing cell 910 and is allowed to escape 920 outside the system.

This operation is preferably carried out when (a) the SOC of the negolyte solution 902 is less than 100% (e.g. <99%, <90%, <80%, <60%, <40%, <20%, <10%, or 0%) so that it can continue to accept electrons at the first electrode 914, and (b) the SOC of the posolyte solution 904 is close to or at 100% (e.g. >60%, >80%, >90%, >95%, >98%, >99%, >99.5%, >99.8%, >99.9%, or 100%), so that the proportion of posolyte solution 904 that is re-oxidized at the second electrode 915 is small relative to the amount of oxygen produced. This also has the benefit of minimizing any opportunity for the oxygen that is evolved from second electrode 915 to redissolve in the posolyte solution 904 and eventually diffuse back into the negolyte solution 902, rather than escaping 920 from the system. The electrical potential supplied from the external power supply 916 can be changed, reduced, or switched off once the SOC imbalance between the negolyte solution 902 and the posolyte solution 904 decreases below a threshold value.

As hydroxide ions are formed in the negolyte solution 902 through reaction with oxygen, but consumed through the formation of protons (or hydronium ions) at the bipolar membrane 913 that are conducted to the negolyte solution 902 in the first chamber 911, there is no net change to the ionic strength (or osmotic potential) of the negolyte solution 902 as a result of oxygen absorption followed by rebalancing. Hydroxide ions produced at the bipolar membrane 913 are conducted to the posolyte solution 904 in the second chamber 912 where they are consumed in equal quantities at the second electrode 915. Note that water molecules are produced in the negolyte solution 902 and at the second electrode 915, but also consumed in equal quantity within the bipolar membrane 913. Therefore, this embodiment does not experience any long-term net transport of water from the negolyte solution 902 to the posolyte solution 904, or vice versa. The use of a bipolar membrane allows for osmotic neutrality to be maintained even if the oxygen evolution from the second electrode 915 is occurring at the posolyte solution 904. This has the additional benefit of not exposing the oxygen evolution electrocatalyst on the second electrode 915 to a reducing chemical environment (e.g. negolyte solution 902 at high SOC) where it might be unstable.

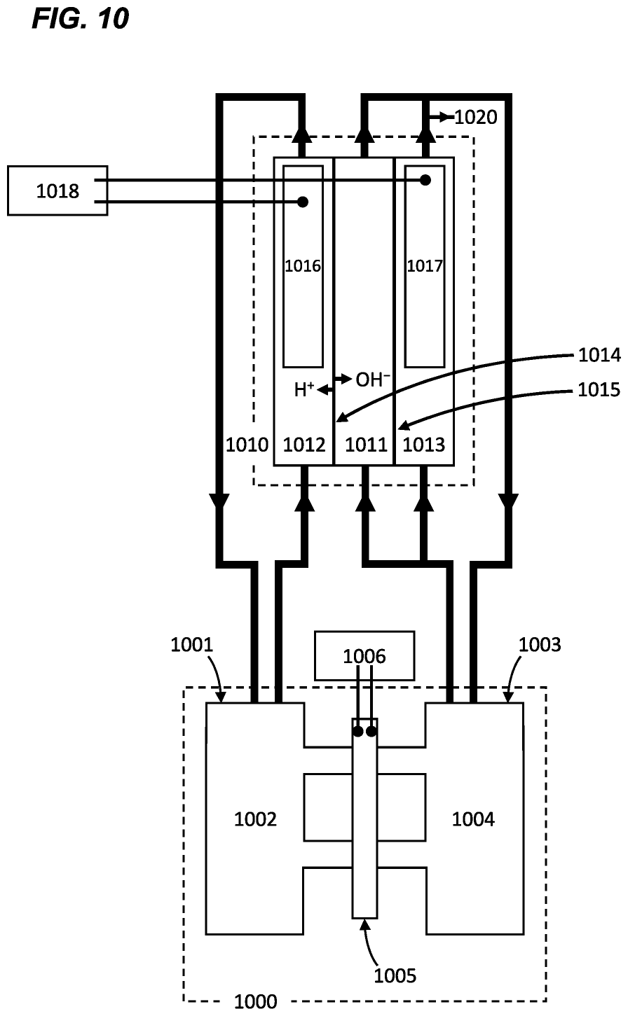

FIG. 10 shows a redox flow battery 1000 and rebalancing cell 1010 in accordance with some embodiments of the present invention. The flow battery 1000 comprises a negolyte tank 1001 filled with a negolyte solution 1002, a posolyte tank 1003 filled with a posolyte solution 1004, and a redox flow battery stack 1005 that is connected to an external load or power supply 1006. The negolyte solution 1002 can be a negatively charged quinone derivative dissolved in water, and the posolyte solution 1004 can be a negatively charged Fe(CN) solution dissolved in water. Both the negolyte and posolyte solutions 1002, 1004 can use potassium hydroxide, sodium hydroxide, or a mixture of both as a supporting electrolyte. This rebalancing cell 1010 comprises a first chamber 1011 that is bounded on one side by a bipolar membrane 1014 and a second chamber 1012, and bounded on the other side by an ion-selective membrane 1015 and a third chamber 1013. The bipolar membrane 1014 is positioned such that it generates hydroxide ions that enter the first chamber 1011 and protons (or hydronium ions) that enter the second chamber 1012 upon the application of a suitable electrical potential across the bipolar membrane 1014. The ion-selective membrane 1015 can be a cation-exchange membrane that lets potassium or sodium ions pass through freely.

The second chamber 1012 contains a first electrode 1016 and the third chamber 1013 contains a second electrode 1017. The first electrode 1016 can comprise a conductive carbon material such as carbon cloth with no other electrocatalyst, and the second electrode 1017 can comprise nickel/iron oxyhydroxide. The two electrodes 1016, 1017 are connected to an external power supply 1018.

The negolyte solution 1002 is circulated from the negolyte tank 1001 into the second chamber 1012, past the first electrode 1016, and back again from the second chamber 1012 to the negolyte tank 1001.

The posolyte solution 1004 is circulated from the posolyte tank 1003 into both the first and third chambers 1011, 1013 and back again from both the chambers 1011, 1013 back to the posolyte tank 1003. Posolyte solution that passes through the third chamber 1013 flows past the second electrode 1017.

When an appropriate electrical potential is applied across the electrodes 1016, 1017 of the rebalancing cell 1010 using external power supply 1018, the negolyte solution 1002 is reduced (its SOC is raised) at the first electrode 1016. At the same time, water (or hydroxide ions) in the posolyte solution 1004 is oxidized at the second electrode 1017 to form oxygen gas that leaves the rebalancing cell 1010 and is allowed to escape 1020 outside the system. At the same time, water splitting happens within the bipolar membrane 1014 to release hydroxide ions that enter the first chamber 1011 and protons (or hydronium ions) that enter the second chamber 1012.

This operation is preferably carried out when (a) the SOC of the negolyte solution 1002 is less than 100% (e.g. <99%, <90%, <80%, <60%, <40%, <20%, <10%, or 0%) so that it can continue to accept electrons at the first electrode 1016, and (b) the SOC of the posolyte solution 1004 is close to or at 100% (e.g. >60%, >80%, >90%, >95%, >98%, >99%, >99.5%, >99.8%, >99.9%, or 100%), so that the proportion of posolyte solution 1004 that is re-oxidized at the second electrode 1017 is small relative to the amount of oxygen produced. This also has the benefit of minimizing any opportunity for the oxygen that is evolved from second electrode 1017 to redissolve in the posolyte solution 1004 and eventually diffuse back into the negolyte solution 1002, rather than escaping 1020 from the system. The electrical potential supplied from the external power supply 1018 can be changed, reduced, or switched off once the SOC imbalance between the negolyte solution 1002 and the posolyte solution 1004 decreases below a threshold value.

Other embodiments are possible in which the identities of first and second electrodes 1016, 1017 are swapped. In these embodiments, the external voltage supplied from external power supply 1018 causes oxygen evolution to take place at the first electrode 1016 that contacts the negolyte solution, and reduction of the posolyte solution to take place in the third chamber 1013, thereby lowering its SOC.

There, operation is preferably carried out when (a) the SOC of the posolyte solution 1004 is greater than 0% (e.g. >1%, >10%, >20%, >40%, >60%, >80%, >90%, or 100%), so that it can continue to accept electrons at the second electrode 1017, and (b) the SOC of the negolyte solution 1002 is close to or at 0% (e.g. <40%, <20%, <10%, <5%, <2%, <1%, <0.5%, <0.2%, <0.1%, or 0%), so that the proportion of negolyte solution 1002 that is re-oxidized at the first electrode 1016 is small relative to the amount of oxygen produced. This also has the benefit of minimizing any opportunity for the oxygen that is evolved from the first electrode 1016 to react again with the negolyte solution 1002 before it can escape 1020 from the system. The electrical potential supplied from the external power supply 1018 can again be changed, reduced, or switched off once the SOC imbalance between the negolyte solution 1002 and the posolyte solution 1004 decreases below a threshold value.

As hydroxide ions are formed in the negolyte solution 1002 through reaction with oxygen, but consumed through the formation of protons (or hydronium ions) at the bipolar membrane 1014, there is no net change to the ionic strength (or osmotic potential) of the negolyte solution 1002 as a result of oxygen absorption followed by rebalancing. Hydroxide ions produced at the bipolar membrane 1014 are conducted to the posolyte solution 1004 in the first chamber 1011 and flowed to the third chamber 1013 and consumed in equal quantities at the second electrode 1017. Note that water molecules are produced in the negolyte solution 1002 and at the second electrode 1017, but also consumed in equal quantity within the bipolar membrane 1014. Therefore, this embodiment does not experience any long-term net transport of water from the negolyte solution 1002 to the posolyte solution 1004, or vice versa. The use of a bipolar membrane allows for osmotic neutrality to be maintained even if the oxygen evolution from the second electrode 1017 is occurring at the posolyte solution 1004. This has the additional benefit of not exposing the oxygen evolution electrocatalyst on the second electrode 1017 to a reducing chemical environment (e.g. negolyte solution 1002 at high SOC) where it might be unstable.

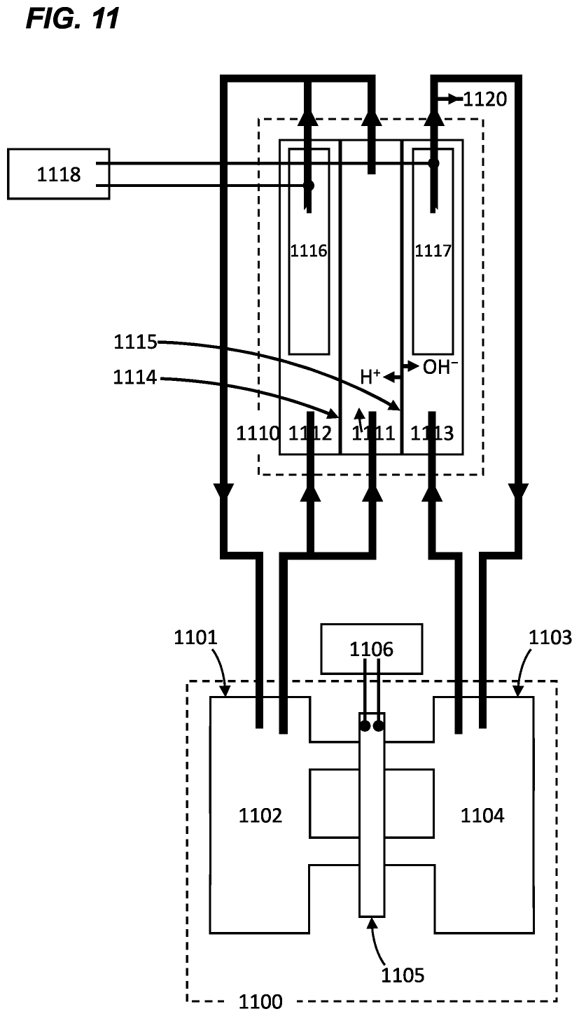

FIG. 11 shows a redox flow battery 1100 and rebalancing cell 1110 in accordance with some embodiments of the present invention. The flow battery 1100 comprises a negolyte tank 1101 filled with a negolyte solution 1102, a posolyte tank 1103 filled with a posolyte solution 1104, and a redox flow battery stack 1105 that is connected to an external load or power supply 1106. The negolyte solution 1102 can be a negatively charged quinone derivative dissolved in water, and the posolyte solution 1104 can be a negatively charged Fe(CN) solution dissolved in water. Both the negolyte and posolyte solutions 1102, 1104 can use potassium hydroxide, sodium hydroxide, or a mixture of both as a supporting electrolyte. This rebalancing cell 1110 comprises a first chamber 1111 that is bounded on one side by an ion-selective membrane 1114 and a second chamber 1112, and bounded on the other side by a bipolar membrane 1115 and a third chamber 1113. The bipolar membrane 1115 is positioned such that it generates hydroxide ions that enter the third chamber 1113 and protons (or hydronium ions) that enter the first chamber 1111 upon the application of a suitable electrical potential across the bipolar membrane 1115. The ion-selective membrane 1114 can be a cation-exchange membrane that lets potassium or sodium ions pass through freely.

The second chamber 1112 contains a first electrode 1116 and the third chamber 1113 contains a second electrode 1117. The first electrode 1116 can comprise a conductive carbon material such as carbon cloth with no other electrocatalyst, and the second electrode 1117 can comprise nickel/iron oxyhydroxide. The two electrodes 1116, 1117 are connected to an external power supply 1118.

The negolyte solution 1102 is circulated from the negolyte tank 1101 into both the first and second chambers 1111, 1112 and back again from both the chambers 1111, 1112 back to the negolyte tank 1101. Negolyte solution that passes through the second chamber 1112 flows past the first electrode 1116.

The posolyte solution 1104 is circulated from the posolyte tank 1103 into the third chamber 1113, past the second electrode 1117, and back again from the third chamber 1113 to the posolyte tank 1103.

When an appropriate electrical potential is applied across the electrodes 1116, 1117 of the rebalancing cell 1110 using external power supply 1118, the negolyte solution 1102 is reduced (its SOC is raised) at the first electrode 1116. At the same time, water (or hydroxide ions) in the posolyte solution 1104 is oxidized at the second electrode 1117 to form oxygen gas that leaves the rebalancing cell 1110 and is allowed to escape 1120 outside the system. At the same time, water splitting happens within the bipolar membrane 1115 to release hydroxide ions that enter the third chamber 1113 and protons (or hydronium ions) that enter the first chamber 1111.

This operation is preferably carried out when (a) the SOC of the negolyte solution 1102 is less than 100% (e.g. <99%, <90%, <80%, <60%, <40%, <20%, <10%, or 0%) so that it can continue to accept electrons at the first electrode 1116, and (b) the SOC of the posolyte solution 1104 is close to or at 100% (e.g. >60%, >80%, >90%, >95%, >98%, >99%, >99.5%, >99.8%, >99.9%, or 100%), so that the proportion of posolyte solution 1104 that is re-oxidized at the second electrode 1117 is small relative to the amount of oxygen produced. This also has the benefit of minimizing any opportunity for the oxygen that is evolved from second electrode 1117 to redissolve in the posolyte solution 1104 and eventually diffuse back into the negolyte solution 1102, rather than escaping 1120 from the system. The electrical potential supplied from the external power supply 1118 can be changed, reduced, or switched off once the SOC imbalance between the negolyte solution 1102 and the posolyte solution 1104 decreases below a threshold value.

Other embodiments are possible in which the identities of first and second electrodes 1116, 1117 are swapped. In these embodiments, the external voltage supplied from external power supply 1118 causes oxygen evolution to take place at the first electrode 1116 that contacts the negolyte solution, and reduction of the posolyte solution to take place in the third chamber 1113, thereby lowering its SOC.

There, operation is preferably carried out when (a) the SOC of the posolyte solution 1104 is greater than 0% (e.g. >1%, >10%, >20%, >40%, >60%, >80%, >90%, or 100%) so that it can continue to accept electrons at the second electrode 1117, and (b) the SOC of the negolyte solution 1102 is close to or at 0% (e.g. <40%, <20%, <10%, <5%, <2%, <1%, <0.5%, <0.2%, <0.1%, or 0%), so that the proportion of negolyte solution 1102 that is re-oxidized at the first electrode 1116 is small relative to the amount of oxygen produced. This also has the benefit of minimizing any opportunity for the oxygen that is evolved from the first electrode 1116 to react again with the negolyte solution 1102 before it can escape 1120 from the system. The electrical potential supplied from the external power supply 1118 can again be changed, reduced, or switched off once the SOC imbalance between the negolyte solution 1102 and the posolyte solution 1104 decreases below a threshold value.

As hydroxide ions are formed in the negolyte solution 1102 through reaction with oxygen, but consumed through the formation of protons (or hydronium ions) at the bipolar membrane 1115, there is no net change to the ionic strength (or osmotic potential) of the negolyte solution 1102 as a result of oxygen absorption followed by rebalancing. Hydroxide ions produced at the bipolar membrane 1115 are conducted to the posolyte solution 1104 in the third chamber 1113 and consumed in equal quantities at the second electrode 1117. Note that water molecules are produced in the negolyte solution 1102 and at the second electrode 1117, but also consumed in equal quantity within the bipolar membrane 1115. Therefore, this embodiment does not experience any long-term net transport of water from the negolyte solution 1102 to the posolyte solution 1104, or vice versa. The use of a bipolar membrane allows for osmotic neutrality to be maintained even if the oxygen evolution from the second electrode 1117 is occurring at the posolyte solution 1104. This has the additional benefit of not exposing the oxygen evolution electrocatalyst on the second electrode 1117 to a reducing chemical environment (e.g. negolyte solution 1102 at high SOC) where it might be unstable.

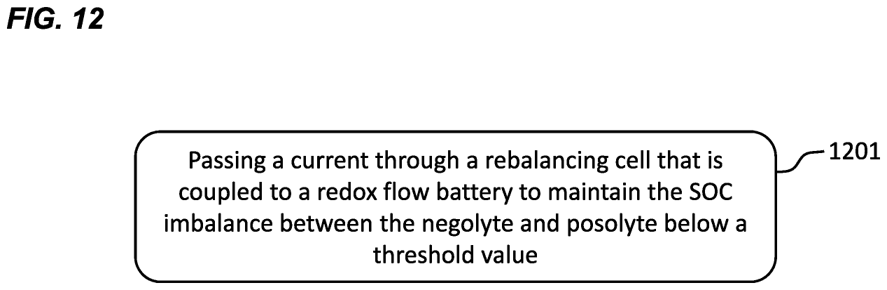

FIGS. 12-14 illustrate example methods for operating a redox flow battery equipped with a rebalancing cell, as described above, in an energy storage system. In these examples, the flow battery is cycled (charged and discharged) using methods typical to the operation of flow batteries. The cycling process should also be understood to include any rest (idle) periods and electrochemical capacity recovery techniques (e.g. aeration of the negolyte, electrochemical re-oxidation of the negolyte, periodic deep discharges, etc.) not involving the rebalancing cell. The overall system comprising the redox flow battery and rebalancing cell can be operated using one or a combination of these methods.

For the method in FIG. 12, the rebalancing cell is operated (i.e. an electrical current is passed through it) at a constant voltage, constant current, or similar substantially constantly-on conditions 1201, independent of the cycling of the redox flow battery, such that the SOC imbalance between the negolyte and posolyte is maintained below a threshold value. In other words, the average rate of oxygen production from the rebalancing cell is approximately the average rate of absorption of oxygen into the posolyte and negolyte solutions.

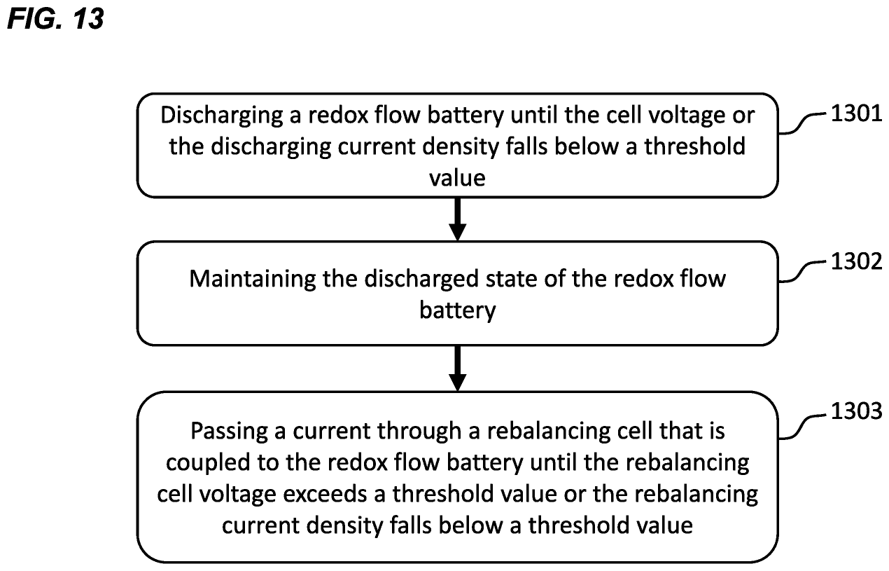

For the method in FIG. 13, the redox flow battery is first discharged 1301 such that the cell voltage or discharging current density of the redox flow battery falls below a threshold value. The cell voltage or current density can be used as a proxy for the approximate SOC of the flow battery, so this ensures that the SOC of the negolyte solution is low, close to or at 0% (e.g. <40%, <20%, <10%, <5%, <2%, <1%, <0.5%, <0.2%, <0.1%, or 0%). Then, while the flow battery is kept in this discharged state 1302, the rebalancing cell is operated 1303 (i.e. an electrical current is passed through it) until the cell voltage of the rebalancing cell exceeds a threshold value or the current density of the rebalancing cell falls below a threshold value. When this happens, the SOC imbalance between the negolyte and posolyte solutions has been reduced to a low level, close to or at 0% (e.g. <20%, <10%, <5%, <2%, <1%, <0.5%, <0.2%, <0.1%, or 0%). This method can be employed at the end of every charge-discharge cycle of the redox flow battery, at the end of every given number of cycles, or after a predetermined amount of time has passed.

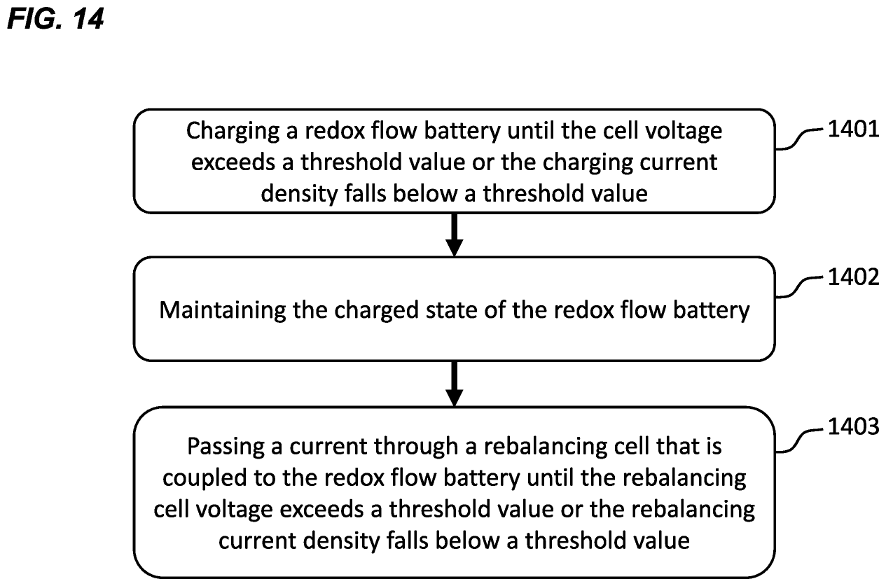

For the method in FIG. 14, the redox flow battery is first charged 1401 such that the cell voltage exceeds a threshold value or the charging current density of the redox flow battery falls below a threshold value. The cell voltage or current density can be used as a proxy for the approximate SOC of the flow battery, so this ensures that the SOC of the posolyte solution is high, close to or at 100% (e.g. >60%, >80%, >90%, >95%, >98%, >99%, >99.5%, >99.8%, >99.9%, or 100%). Then, while the flow battery is kept in this charged state 1402, the rebalancing cell is operated 1403 (i.e. an electrical current is passed through it) until the cell voltage of the rebalancing cell exceeds a threshold value or the current density of the rebalancing cell falls below a threshold value. When this happens, the SOC imbalance between the negolyte and posolyte solutions has been reduced to a low level, close to or at 0% (e.g. <20%, <10%, <5%, <2%, <1%, <0.5%, <0.2%, <0.1%, or 0%). This method can be employed at the end of every discharge-charge cycle of the redox flow battery, at the end of every given number of cycles, or after a predetermined amount of time has passed.

For all methods depicted in FIGS. 12-14, specifically steps 1203, 1303, or 1403, part of the current that is passed through the rebalancing cell can be directed to water oxidation (i.e. oxygen evolution) as originally intended, while part of the current can be additionally directed to oxidizing degraded negolyte reactant back into the original negolyte reactant and thereby restoring the charge capacity of the negolyte.

### Example 1

Two separate cells were constructed. One of the cells, called the redox flow battery cell, was used for charging/discharging a flow battery composed of DCDHAQ (1,8-dihydroxy-2,7-bis(carboxymethyl)-9,10-anthraquinone) as the negolyte active material and a combination of sodium ferrocyanide and potassium ferrocyanide in a 1:1 molar ratio as the posolyte active material. The second cell, called the rebalancing cell, was used intermittently to counteract the imbalance caused by exposure to oxygen. Both cells were run open to air, rather than inside an inert atmosphere glove box or under a protective blanket of inert gas.

Both the redox flow battery cell and rebalancing cell were composed of hardware purchased from Fuel Cell Technologies (Albuquerque, NM). Both cells used resin-impregnated graphite flow plates with serpentine flow designs and a 50 cm² geometric surface area. For both sides of the redox flow battery cell and also the cathode (negative electrode) side of the rebalancing cell, two pieces each of thermally activated AvCarb carbon paper (EP-40) were used. For the anode (positive electrode) side of the rebalancing cell at which an oxygen evolution reaction would take place, a piece of nickel wire mesh with a wire diameter of 0.016″ and a mesh size of 20×20 (# of openings/inch) was used. For the redox flow battery cell, an FKE-50 membrane was used to serve as the ion-selective membrane. For the rebalancing cell, a piece of Fumatech FBM bipolar membrane was used. The FBM membrane was oriented such that protons would be generated at the cathode side of the rebalancing cell and hydroxide ions would be generated at the anode side of the rebalancing cell. Viton sheets were used to cover the outer portion space between the electrodes. The torque used for cell assembly was 60 lb-in (6.78 Nm) on each of eight 1/4-28 bolts.

The redox flow battery cell and rebalancing cell were set up with reservoirs in a configuration identical to FIG. 2. All electrolyte flow rates were set to 225 mL/min, and were driven by KNF NF60 pumps. In some situations, a blanket of nitrogen was kept on the negolyte of the redox flow battery cell. Charge/discharge of the cycling cell was performed using an Arbin battery tester, while the rebalancing cell was electrically connected to, and operated using, a Bio-Logic VSP-300 potentiostat.

The negolyte of the redox flow battery cell was composed of 100 mL of 0.08 M DCDHAQ, adjusted to pH 14 with a 1:1 molar ratio of sodium and potassium hydroxide. The posolyte of the redox flow battery cell was composed of 55 mL of 0.15 M sodium ferrocyanide, 0.15 M potassium ferrocyanide, and 0.10 M potassium ferricyanide, adjusted to pH 14 with a 1:1 molar ratio of sodium and potassium hydroxide. For simplicity, the anode compartment of the rebalancing cell contained 100 ml of a 1:1 molar ratio of sodium and potassium hydroxide with a total hydroxide concentration of 3 M.

Charging/discharging of the redox flow battery cell was performed galvanostatically at ±100 mA cm⁻² until the charging potential reached 1.55 V or the discharging potential reached 0.65 V, at which point the redox flow battery cell was maintained at those potentials until the current density dropped to 5 mA cm⁻², at which point the next half-cycle (discharging/charging) was started. The rebalancing cell was kept off most of the time, but when it was in operation, after current was passed galvanostatically at 10 mA cm⁻² until the potential reached 2.3 V, at which point the rebalancing cell current was passed potentiostatically until the current density dropped below 3 mA cm⁻². Typically, at this point, bubbles of hydrogen gas started forming at the cathode (negative electrode) side of the rebalancing cell. A higher cut off threshold current density for the rebalancing cell would avoid the formation of any hydrogen gas at the cathode of the rebalancing cell. During a rebalancing operation, the cycling sequence was as follows—(1) Charge the redox flow battery cell until the threshold is reached, (2) Pass current through the rebalancing cell until the threshold is reached, then (3) discharge the redox flow battery cell until the threshold is reached. Note that many other cycling sequences including simultaneous operation of the redox flow battery cell and the rebalancing cell are possible but were not tested here.

In this cycling sequence, during the charging step of the redox flow battery cell, a portion of the negolyte constantly gets oxidized by oxygen present in air. Thus, more ferrocyanide is oxidized to charge the negolyte fully. This process continues until the posolyte does not have any excess to keep up with the negolyte oxidation due to contact with air. After this point, the capacity of the cell would be limited by the posolyte although it was originally limited by the negolyte.

In order to counteract the effect of oxygen, the rebalancing cell was run intermittently. After charging the catholyte fully in Step (1) in the cycling sequence above, with the capacity limit imposed by the posolyte as described above, a valve is opened to allow negolyte fluid to circulate to the cathode compartment of the rebalancing cell and Step (2) is started. After Step (2) is complete, the valve is shut and Step (3) follows.

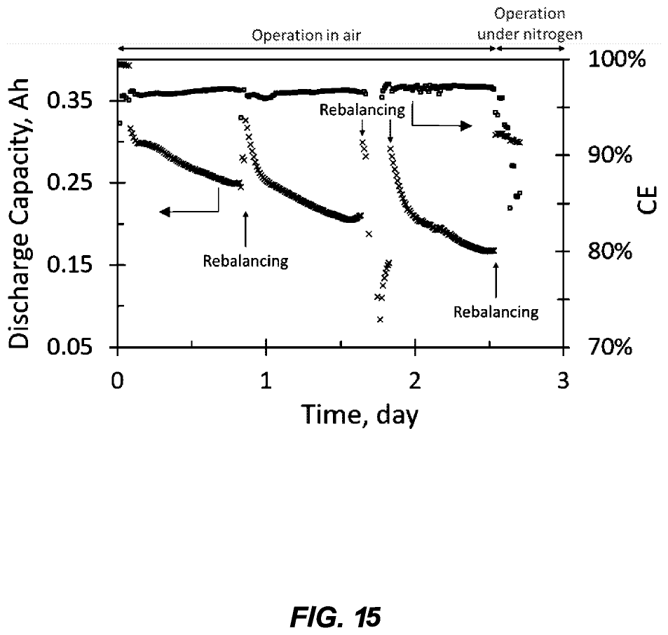

FIG. 15 shows the capacity and coulombic efficiency of the cycling cell over time. The capacity appears to be stable for the first few cycles (˜0.1 days) because there is a small excess of posolyte. Beyond that, as oxygen continues to lower the state of charge of (i.e., oxidize) the negolyte, there is insufficient posolyte to allow the negolyte to become fully charged, and the capacity appears to decline quickly.

A sharp increase in the capacity of the redox flow battery cell is seen after each rebalancing cycle, as indicated on FIG. 15. The capacity still drops quickly after rebalancing, most likely because aerobic oxidation occurs at a faster rate when the concentration of reduced DCDHAQ is higher. To prove that the decline in capacity is largely due to the effect of atmospheric oxygen, the negolyte reservoir (but not the posolyte or the rest of the system) was placed under a blanket of ultrapure nitrogen at the ˜2.5 day mark, immediately before the last rebalancing procedure, whereupon a slowdown of the rate of capacity decrease is immediately observed. During the entire period, no change in the fluid levels of the posolyte, negolyte, or anode reservoir of the rebalancing cell could be observed. The results show that a rebalancing cell with a bipolar membrane can restore lost capacity in a redox flow battery system that is caused by an imbalance in the posolyte and negolyte states of charge, whether caused by oxygen or some other process.

Unless otherwise indicated, all numbers expressing feature sizes, amounts, volumes, charge capacities, states of charge, and other chemical and physical properties used in the specification and claims are to be understood as being modified in all instances by the term “about”. Accordingly, unless indicated to the contrary, the numerical parameters set forth in the foregoing specification and attached claims are approximations that can vary depending on the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5; <10% includes 10%, 9.8%, 5.5%, 2%, 0.01%, and 0%; >90% includes 90%, 90.2%, 94.5%, 98%, 99.99%, and 100%) and any range within that range.

The foregoing description has been presented for the purposes of illustration and description. It is not intended to be exhaustive or to limit the embodiments to the precise form disclosed. Many modifications and variations are possible in light of the above teachings. Any or all features of the disclosed embodiments can be applied individually or in any combination and are not meant to be limiting, but purely illustrative. It is intended that the scope of the invention be limited not with this detailed description, but rather, determined by the claims appended hereto.

1. A redox flow battery system, comprising:
a redox flow battery apparatus comprising:
a first tank comprising a negolyte solution, the negolyte comprising a quinone;
a second tank comprising a posolyte solution; and
a flow battery stack capable of extracting electrical energy from a chemical reaction of the negolyte and posolyte solutions, and of supplying electrical energy to cause the reverse reaction in the negolyte and posolyte solutions;
a rebalancing apparatus, comprising:
a first electrode; and
a second electrode comprising an oxygen evolution reaction catalyst;
wherein the rebalancing apparatus is configured to accept at least one of the negolyte or posolyte solutions from a source tank that is one of the first tank and the second tank, modify the negolyte solution or the posolyte solution of the source tank, and return the modified solution to the source tank; and
wherein the flow battery stack is configured to accept the negolyte solution from the first tank and return negolyte solution back to the first tank and to accept the posolyte solution from the second tank and return posolyte solution back to the second tank.

2. The system of claim 1, wherein the negolyte and posolyte solution each have a pH greater than 7.

3. The system of claim 2, wherein the second electrode comprises platinum, nickel, nickel-iron, nickel oxyhydroxide, or nickel-iron oxyhydroxide.

4. The system of claim 1, wherein the negolyte and posolyte solution each have a pH is lower than 7.

5. The system of claim 4, wherein the second electrode comprises platinum, ruthenium oxide, or iridium oxide.

6. The system of claim 1, wherein the rebalancing apparatus is additionally configured to perform an oxidation reaction on the negolyte solution through the second electrode.

7. The system of claim 1, additionally comprising an outlet to expel or release gaseous products formed at the second electrode.

8. The system of claim 1, wherein the first and second electrodes of the rebalancing apparatus are integrated into either the first tank or the second tank of the redox flow battery apparatus.

9. The system of claim 8, additionally comprising an outlet to expel or release gaseous products formed at the second electrode, and a conduit to gather and direct bubbles of gaseous products formed at the second electrode towards the outlet.

10. The system of claim 1, additionally comprising a first separator that divides the rebalancing apparatus in a way that defines a first chamber and a second chamber, the first chamber comprising the first electrode and the second chamber comprising the second electrode.

11. The system of claim 10, wherein the first separator is an anion exchange membrane or a cation exchange membrane.

12. The system of claim 10, wherein the first chamber and second chamber are configured to receive the negolyte solution from the first tank of the redox flow battery apparatus, and return the modified negolyte solution from the first chamber and second chamber back to the first tank of the redox flow battery apparatus.

13. The system of claim 10, wherein the first chamber and second chamber are configured to receive the posolyte solution from the second tank of the redox flow battery apparatus, and return the modified posolyte solution from the first chamber and second chamber back to the second tank of the redox flow battery apparatus.

14. The system of claim 10, additionally comprising:
a supporting electrolyte tank and supporting electrolyte solution;
the second chamber configured to receive the supporting electrolyte solution from the supporting electrolyte tank and return the supporting electrolyte solution back to the supporting electrolyte tank,
the first chamber configured to receive the negolyte solution from the first tank of the redox flow battery apparatus and return the modified negolyte solution back to the first tank of the redox flow battery apparatus; and
the supporting electrolyte solution has an osmotic pressure greater than that of the negolyte solution.

15. The system of claim 10, additionally comprising:
a supporting electrolyte tank and supporting electrolyte solution;
the second chamber configured to receive the supporting electrolyte solution from the supporting electrolyte tank and return the supporting electrolyte solution back to the supporting electrolyte tank;
the first chamber configured to receive the posolyte solution from the second tank of the redox flow battery apparatus and return the modified posolyte solution back to the second tank of the redox flow battery apparatus; and
the supporting electrolyte solution has an osmotic pressure greater than that of the posolyte solution.

16. The system of claim 10, wherein:
the first chamber is configured to receive the posolyte solution from the second tank of the redox flow battery apparatus and return the posolyte solution from the second chamber back to the second tank of the redox flow battery apparatus, and
the second chamber is configured to receive the negolyte solution from the first tank of the redox flow battery apparatus and return the modified negolyte solution back to the first tank of the redox flow battery apparatus.

17. The system of claim 10, additionally comprising a second separator disposed between the first separator and the second electrode, thereby defining a third chamber between the first separator and the second separator, this third chamber located between the first chamber and the second chamber.

18. The system of claim 17, wherein the first separator is a bipolar membrane configured to supply protons to the first chamber and hydroxide ions to the third chamber, and the second separator is an anion exchange membrane or a cation exchange membrane.

19. The system of claim 18, wherein:
the first chamber is configured to receive the negolyte solution from the first tank of the redox flow battery apparatus and return the modified negolyte solution back to the first tank of the redox flow battery apparatus;
the second chamber is configured to receive the posolyte solution from the second tank of the redox flow battery apparatus and return the modified posolyte solution back to the second tank of the redox flow battery apparatus; and
the third chamber is configured to receive either the posolyte solution or the negolyte solution from the first tank or the second tank of the redox flow battery apparatus, and return the modified solution back to the source tank of the redox flow battery apparatus.

20. The system of claim 17, wherein the first separator is an anion exchange membrane or a cation exchange membrane, and the second separator is a bipolar membrane configured to supply protons to the third chamber and hydroxide ions to the second chamber.

21. The system of claim 20, wherein:
the first chamber is configured to receive the negolyte solution from the first tank of the redox flow battery apparatus and return the modified negolyte solution back to the first tank of the redox flow battery apparatus;
the second chamber is configured to receive the posolyte solution from the second tank of the redox flow battery apparatus and return the modified posolyte solution back to the second tank of the redox flow battery apparatus; and
the third chamber is configured to receive either the posolyte solution or the negolyte solution from the first tank or the second tank of the redox flow battery apparatus, and return the modified solution back to the source tank of the redox flow battery apparatus.

22. The system of claim 11, wherein the first separator is a bipolar membrane.

23. A method, comprising:
providing a redox flow battery system, comprising:
a redox flow battery apparatus, comprising:
a first tank comprising a negolyte solution, the negolyte solution comprising a quinone;
a second tank comprising a posolyte solution; and
a flow battery stack capable of extracting electrical energy from a chemical reaction of the negolyte and posolyte solutions, and of supplying electrical energy to cause the reverse reaction in the negolyte and posolyte solutions;
the flow battery stack configured to accept the negolyte solution from the first tank and return negolyte solution back to the first tank, and configured to accept the posolyte solution from the second tank and return posolyte solution back to the second tank;
a rebalancing apparatus, comprising:
a first electrode; and
a second electrode comprising an oxygen evolution reaction catalyst, the rebalancing apparatus configured to accept at least one of the negolyte or posolyte solutions from a source tank or tanks and return a modified solution or solutions back to the respective source tank or tanks from which the negolyte or posolyte solution was received; and
passing a current through the rebalancing apparatus to maintain the state of charge imbalance between the negolyte and posolyte below a threshold value.

24. A method, comprising:
providing the redox flow battery system of claim 23;
discharging the redox flow battery apparatus until the cell voltage or the discharging current density falls below a threshold value;
maintaining the discharged state of the redox flow battery apparatus; and
passing a current through the rebalancing apparatus until the rebalancing cell voltage exceeds a threshold value or the rebalancing current density falls below a threshold value.

25. The method of claim 24, wherein the rebalancing apparatus is additionally configured to perform an oxidation reaction on the negolyte solution through the second electrode.

26. A method, comprising:
providing the redox flow battery system of claim 23;
charging the redox flow battery apparatus until the cell voltage exceeds a threshold value or the charging current density falls below a threshold value;
maintaining the charged state of the redox flow battery apparatus; and
passing a current through the rebalancing apparatus until the rebalancing cell voltage exceeds a threshold value or the rebalancing current density falls below a threshold value.

27. The method of claim 26, wherein the rebalancing apparatus is additionally configured to perform an oxidation reaction on the negolyte solution through the second electrode.

28. A method, comprising:
providing the redox flow battery system of claim 23, wherein the rebalancing apparatus is additionally configured to perform an oxidation reaction on the negolyte solution through the second electrode; and
passing a current through the rebalancing apparatus, where part of the current through the rebalancing apparatus is directed to water oxidation at the second electrode, and
part of the current through the rebalancing apparatus is directed to oxidizing degraded negolyte in a way that restores the charge capacity of the negolyte solution.
